(19) United States
(12) Patent Application Publication
(10) Pub. No.: US 2005/0249278 A1
(43) Pub. Date: Nov. 10, 2005

(54) Moving image coding method, moving image decoding method, moving image coding device, moving image decoding device, moving image coding program and program product of the same

(75) Inventors: Hisao Sasai, Osaka city (JP); Satoshi Kondo, Yawata city (JP)

Correspondence Address: WENDEROTH, LIND & PONACK, L.L.P., 2033 K STREET N. W., SUITE 800, WASHINGTON, DC, 20006-1021, US

(73) Assignee: Matsushita Electric Industrial Co., Ltd.

(21) Appl. No.: 11/108,726

(22) Filed: Apr. 19, 2005

(30) Foreign Application Priority Data
Apr. 28, 2004 (JP) 2004-132848

(51) Int. Cl. H04N 7/12

(52) U.S. Cl. 375/240.03; 375/240.12; 375/240.18; 375/240.23

(57) ABSTRACT

A coding mode deciding portion includes a motion vector detecting portion, a prediction image generating portion and an image quality deterioration prediction portion. The image quality deterioration prediction portion generates image quality deterioration prediction information in accordance with second motion associated information that is obtained by the motion vector detecting portion. The generated image quality deterioration prediction information is used for selecting a coding mode and for quantization control.

### BACKGROUND OF THE INVENTION

1. Field of the Invention

The present invention relates to coding and decoding of moving images, and in particular a method for coding moving images and a method for decoding moving images.

2. Background Information

A technique that is called “motion compensation coding” is known as a technique for coding and transmitting image signals at a low bit rate for a television set, a personal computer (PC), a cellular phone or other devices that display image signals.

The motion compensation coding utilizes motion vectors of image blocks that constitute an image frame. For example, two coding methods including intra coding and inter coding are used for coding in accordance with MPEG (Moving Picture Experts Group) that is an international standard of compressing moving image signals.

The intra coding is a method of coding an image frame by using only information within the frame, and a coding mode by this method is called an intra prediction coding mode. The inter coding is a method of coding an image frame by using information of other frames, and a coding mode by this method is called an inter prediction coding mode.

Moreover, each of the intra prediction coding mode and the inter prediction coding mode includes various modes having different generation methods. Therefore, selecting an appropriate coding mode is vital for compressing an image signal efficiently.

In the conventional method, in order to compress an image signal efficiently, a coding mode is selected by measuring or predicting code quantity, generated by coding, and a difference of an input image before and after coding and decoding. To show the difference of the input image, an absolute differential sum or a variance of a prediction error signal is used, for example. Examples of such conventional methods include the following. In one method, a mode is selected in accordance with code quantity generated by coding (see Japanese unexamined patent publication No. H02-29180). In another method, in accordance with code quantity generated by coding including a prediction error and code quantity of motion vectors, a mode having the smallest generated code quantity is selected from among modes having a prediction error signal smaller than a predetermined threshold level (see Japanese unexamined patent publication No. H09-322176, particularly FIG. 15). In yet another method, a mode is selected that becomes optimal in responding to a prediction error signal and generated code quantity within a rectangular small area unit (see Japanese unexamined patent publication No. 2003-153280).

In addition, it is known to change the accuracy of quantization for each rectangular area, a unit of coding in MPEG, so as to adapt to a target bit rate. Moreover, a method is known in which generated code quantity is checked so as to erase the AC component of information to be coded (see Japanese unexamined patent publication No. H11-234677).

Moreover, it is known to give weight to a coefficient of an orthogonal transformation for quantization in MPEG so as to realize a low bit rate. Also, a method is known in which code quantity is further reduced by giving weight to a coefficient of an orthogonal transformation in progress (see Japanese patent No. 3234807).

Here, conventional structures of a coding device and a decoding device will be described with reference to FIGS. 20 and 21.

FIG. 20 is a block diagram showing a structure of a coding device 600.

The coding device 600 codes an input image signal 601 and produces a coded stream 606.

A prediction image generating portion 610 generates a prediction image of the input image signal 601 so as to deliver a prediction image signal 613 and coding mode associated information 614 that is used for generating the prediction image. A motion detecting image signal 612a is entered in a motion vector detecting portion 611 for generating the prediction image. The portion 611 detects motions within the image signal, and delivers motion associated information 612b. A differential signal, obtained by subtracting operation of the input image signal 601 and the prediction image signal 613 by an operating portion 602, is entered in an orthogonal transformation portion 603, and then the portion 603 delivers coefficient information. The coefficient information and a quantization control signal 617, delivered from a quantization control portion 616, are entered in a quantizing portion 604. The portion 604 delivers information that is obtained by quantizing the coefficient information. Code quantity information 619 is entered in the quantization control portion 616, and the portion 616 delivers the quantization control signal 617. Information quantized by the quantizing portion 604 and the coding mode associated information 614 are entered in a variable length coding portion 605, and the portion 605 delivers the coded stream 606. Information quantized by the quantizing portion 604 and the quantization control signal 617 are entered in an inverse quantization portion 607, and the portion 607 delivers coefficient information obtained by inverse quantization. Coefficient information delivered by the inverse quantization portion 607 is entered in an inverse orthogonal transformation portion 608, and the portion 608 delivers differential information obtained by inverse orthogonal transformation. Differential information delivered by the inverse orthogonal transformation portion 608 and the prediction image signal 613 is entered in an operating portion 609, and the portion 609 delivers a decoded image signal 615. A coded stream 606 is entered in a code quantity counter 618, and the counter 618 delivers code quantity information 619.

FIG. 21 is a block diagram showing the structure of a decoding device 700.

A coded stream 701 is entered in a variable length decoding portion 702, and the portion 702 delivers decoding coefficient information 703, decoding quantization control information 704 and motion associated information 705. Decoding coefficient information 703 and quantization control information 709 is entered in an inverse quantization portion 706, and the portion 706 delivers coefficient information 711. Decoding quantization control information 704 is entered in a quantization control portion 707, and the portion 707 delivers quantization control information 709. Coefficient information 711 is entered in an inverse orthogonal transformation portion 712, and the portion 712 delivers differential image signal 713. The differential image signal 713 and a motion compensation image signal 716 are entered in an operating portion 714, and the portion 714 delivers a decoded image signal 719. Motion associated information 705 and a specific decoded image signal 717 are entered in a motion compensating portion 715, and the portion 715 delivers the motion compensation image signal 716 and image area designation information 720. A decoded image signal 719 and image area designation information 720 are entered in an image memory 718, and the image memory 718 delivers the specific decoded image signal 717.

It was found that the difference between an input image and a decoded image such as the prediction error signal used in the conventional method did not accurately reflect subjective image quality, which is obtained by viewing the decoded image. This is mainly because that a human being does not decide image quality based on the difference between the input image and the decoded image. Therefore, if the coding is performed based only on the difference between an input image and a decoded image as a criterion, subjective image quality may be deteriorated particularly in coding a moving image at a low bit rate, although objective image quality may be improved.

In addition, if only generated code quantity is used as a criterion, the same problem will occur. Namely, subjective image quality may be deteriorated particularly in coding a moving image at a low bit rate.

### SUMMARY OF THE INVENTION

An object of the present invention is to reduce code quantity while preventing subjective image quality from being deteriorated.

According to a first aspect of the present invention, there is provided a method for coding a moving image by generating prediction images based upon images that are motion compensated by means of motion information between frames of the moving image, and by coding an input image. The method includes an image quality deterioration prediction process and a code quantity distribution process. The image quality deterioration prediction process is for determining a degree of image quality deterioration of the coded image in accordance with motion information between frames. The code quantity distribution process is for changing a method of distributing the code quantity generated by coding in accordance with the degree of image quality deterioration.

According to a second aspect of the present invention, there is provided a method for coding a moving image by generating a prediction image and coding an input image. The method includes a subtraction process, an orthogonal transformation process, a coefficient modulation process, a modulation mode selection process, a quantization process and a variable length coding process. The subtraction process is for subtracting the prediction image from the input image so as to deliver a differential image. An orthogonal transformation process is for performing an orthogonal transformation on the differential image so as to deliver a transformed coefficient. The coefficient modulation process is for performing a coefficient modulation on the transformed coefficient so as to deliver a modulated coefficient. The modulation mode selection process is for switching among a plurality of modulation mode candidates that indicate degrees of the coefficient modulation. The quantization process is for quantizing the modulated coefficient so as to deliver quantized information. The variable length coding process is for performing variable length coding on the quantized information so as to deliver a coded stream. In addition, the coefficient modulation process performs the coefficient modulation for decreasing a value of the coefficient that indicates a high frequency component of the transformed coefficient by different modulation modes corresponding to degrees of the coefficient modulation. The modulation mode is determined in accordance with generated code quantity of each of the modulation mode candidates and input image difference quantity of each of the modulation mode candidates.

According to a third aspect of the present invention, there is provided a method for decoding a moving image coded stream. The method includes a variable length decoding process, an inverse quantization process, an inverse orthogonal transformation process, an image quality deterioration prediction process, and an image quality improving process. The variable length decoding process is for performing variable length decoding on the moving image coded stream so as to deliver quantized information and motion information. The inverse quantization process is for performing inverse quantization on the quantized information so as to deliver a transformed coefficient. The inverse orthogonal transformation process is for performing inverse orthogonal transformation on the transformed coefficient. The image quality deterioration prediction process is for determining a degree of image quality deterioration of a coded image in accordance with the motion information. The image quality improving process is for improving image quality if the degree of image quality deterioration is high.

According to the present invention, a coded stream having high image quality at a low bit rate can be generated. Moreover, a decoded image having high image quality at a lower bit rate can be generated. Thus, the present invention has a high practical value. In particular, because the degree of image quality deterioration that is not different from the input signal is determined, deterioration of subjective image quality can be suppressed effectively.

These and other objects, features, aspects and advantages of the present invention will become apparent to those skilled in the art from the following detailed description, which, taken in conjunction with the annexed drawings, discloses a preferred embodiment of the present invention.

### BRIEF DESCRIPTION OF THE DRAWINGS

Referring now to the attached drawings which form a part of this original disclosure:

FIG. 1 is a block diagram showing a structure of a coding device according to the present invention (first embodiment);

FIG. 2 is a block diagram showing a structure of a coding mode deciding portion according to the present invention (first embodiment);

FIG. 3 is an explanatory diagram showing a method for detecting motion according to the present invention (first embodiment);

FIG. 4 is an explanatory diagram showing image quality deterioration prediction according to the present invention (first embodiment);

FIG. 5 is a flowchart showing a mode selection method according to the present invention (first embodiment);

FIG. 6 is an explanatory diagram showing coefficient modulation according to the present invention (first embodiment);

FIG. 7 is an explanatory diagram showing a relationship between a motion vector and the accuracy of quantization (first embodiment);

FIG. 8 is a diagram showing a data structure of a coded stream (first embodiment);

FIG. 9 is an explanatory diagram showing a positional relationship of macro blocks (first embodiment);

FIG. 10 is an explanatory diagram showing a relationship between a motion vector and differential information (first embodiment);

FIG. 11 is a flowchart showing a mode selection method as a modification of the first embodiment;

FIG. 12 is a block diagram showing a structure of a coding device as a modification of the first embodiment;

FIG. 13 is a block diagram showing a structure of a decoding device according to the present invention (second embodiment);

FIG. 14 is a flowchart showing the operation of an image quality deterioration prediction portion according to the present invention (second embodiment);

FIG. 15 is a diagram illustrating a recording medium for storing a program for realizing, with a computer system, the data transmission method or the data receiving method according to the above-described embodiments (third embodiment);

FIG. 16 is a block diagram of an overall structure of a contents supplying system (fourth embodiment);

FIG. 17 shows an example of a cellular phone equipped with a moving image coding device according to the present invention (fourth embodiment);

FIG. 18 is a block diagram of the structure of a cellular phone (fourth embodiment);

FIG. 19 shows an example of a digital broadcasting system (fourth embodiment);

FIG. 20 is a block diagram of a coding device for realizing a conventional image coding method (background art); and

FIG. 21 is a block diagram of a decoding device for realizing a conventional image decoding method (background art).

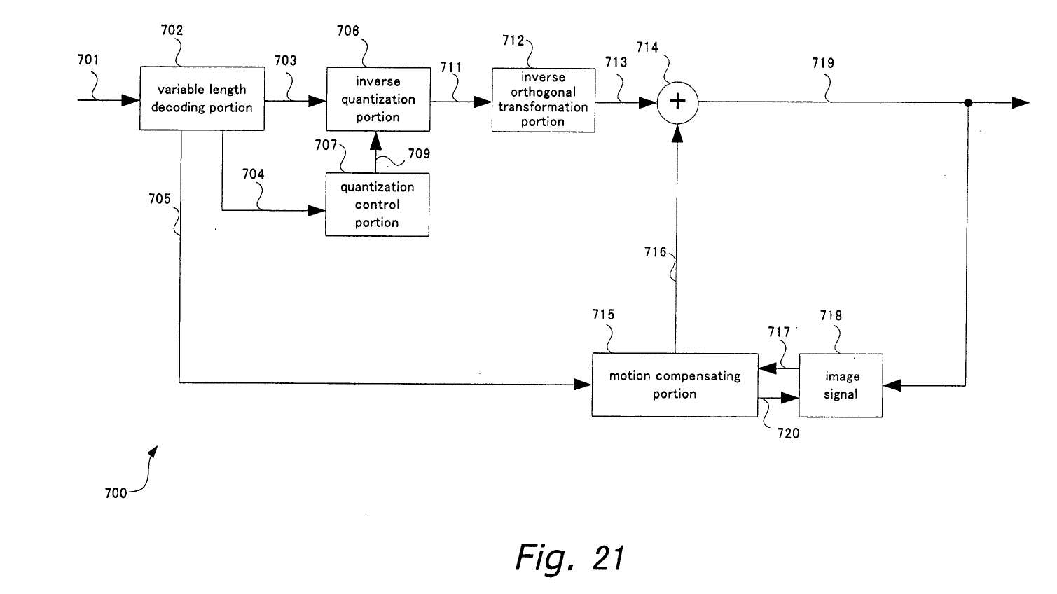

### DETAILED DESCRIPTION OF THE PREFERRED EMBODIMENTS

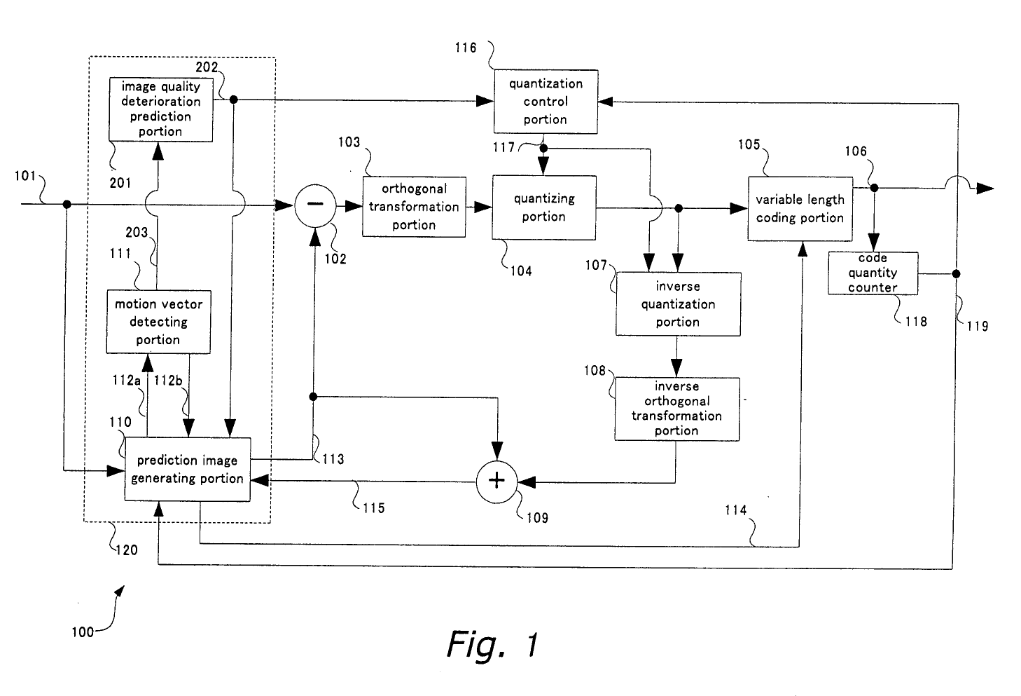

Hereinafter, embodiments of the present invention will be described with reference to FIGS. 1-16.

First embodiment

A moving image coding device (hereinafter referred to as a coding device) according to a first embodiment of the present invention will be described with reference to FIGS. 1-12.

Structure

FIG. 1 is a block diagram showing the structure of a coding device 100.

The coding device 100 codes an input image signal 101 and delivers a coded stream 106.

A prediction image generating portion 1 10 generates a prediction image of the input image signal 101 and delivers a prediction image signal 113 and coding mode associated information 114 that was used for generating the prediction image. Here, the coding mode associated information 114 is, for example, information indicating a coding mode that is used for coding of the input image signal 101 (information indicating a prediction image generation method such as an intra prediction or an inter prediction) or a motion vector that is used for generating a prediction image.

A motion detecting image signal 112a is entered in a motion vector detecting portion 111 for generating a prediction image. Then, the portion 111 detects a motion within the image signal, and delivers first motion associated information 112b and second motion associated information 203.

The second motion associated information 203 is entered in an image quality deterioration prediction portion 201. Then, the portion 201 predicts a degree of occurrence of image quality deterioration, and delivers image quality deterioration prediction information 202. The image quality deterioration prediction information 202 will be explained below.

The prediction image generating portion 110, the motion vector detecting portion 111 and the image quality deterioration prediction portion 201 constitute a coding mode deciding portion 120.

A differential signal, obtained by subtraction process of the input image signal 101 and the prediction image signal 113 by an operating portion 102, is entered in an orthogonal transformation portion 103, and the portion 103 delivers coefficient information. The coefficient information and a quantization control signal 117, delivered by a quantization control portion 116, are entered in a quantizing portion 104, and the portion 104 delivers quantized information of the coefficient information. The image quality deterioration prediction information 202 and code quantity information 119 are entered in the quantization control portion 116, and the portion 116 delivers the quantization control signal 117. The quantized information from the quantizing portion 104 and the coding mode associated information 114 are entered in a variable length coding portion 105, and the portion 105 delivers the coded stream 106. Quantized information from the quantizing portion 104 and the quantization control signal 117 are entered in an inverse quantization portion 107, and the portion 107 delivers the coefficient information obtained by inverse quantization. The coefficient information, delivered by the inverse quantization portion 107, is entered in an inverse orthogonal transformation portion 108, and the portion 107 delivers differential information obtained by inverse orthogonal transformation. The differential information, delivered by the inverse orthogonal transformation portion 108, and the prediction image signal 113 are entered in an operating portion 109, and the portion 109 delivers a decoded image signal 115. The coded stream 106 is entered in a code quantity counter 118, and delivers the code quantity information 119.

In the structure described above, the quantization control portion 116 and the quantizing portion 104 work as a code quantity distributor that changes a method of distributing code quantity generated by coding in accordance with the image quality deterioration prediction information 202. Note that the distribution of code quantity means coding or the like with changing code quantity for each process unit of coding, for example.

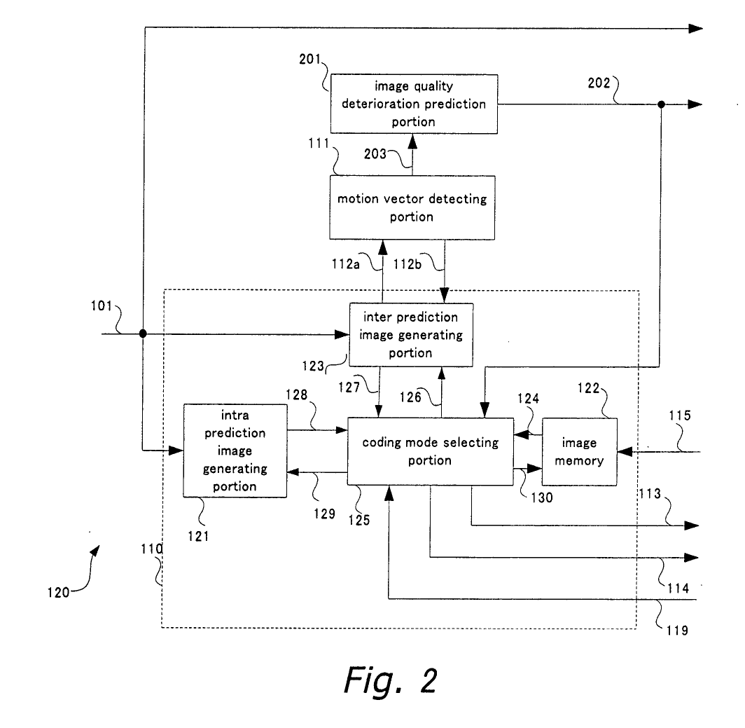

With reference to FIG. 2, the structure of the coding mode deciding portion 120 that constitutes the coding device 100 according to the present invention will be described in more detail.

In the coding mode deciding portion 120, the prediction image generating portion 110 includes an intra prediction image generating portion 121, an image memory 122, an inter prediction image generating portion 123 and a coding mode selecting portion 125.

The intra prediction image generating portion 121 is a method for generating intra prediction information 128 by using intra prediction coding mode information 129 in order to generate the prediction image signal in an intra prediction coding mode.

The image memory 122 is a method for storing the decoded image signal 115 that is an image signal obtained by coding and decoding in advance. Image area designation information 130 is entered in the memory 122, and the memory 122 delivers a specific decoded image signal 124.

The inter prediction image generating portion 123 is a method for generating inter prediction information 127 by using inter prediction coding mode information 126 in order to generate the prediction image signal in an inter prediction coding mode.

The coding mode selecting portion 125 is a method for determining a coding mode from among a plurality of coding modes that were determined in advance in order to obtain the intra prediction information 128 and the inter prediction information 127, and to generate the prediction image signal 113.

The motion detecting image signal 112a is entered in the motion vector detecting portion 111, and the portion 111 delivers the first motion associated information 112b and the second motion associated information 203.

The second motion associated information 203 is entered in the image quality deterioration prediction portion 201, and the portion 201 delivers the image quality deterioration prediction information 202.

Operation

The operation of the coding device 100 will be described.

The input image signal 101 is entered in the operating portion 102 and the prediction image generating portion 110.

Prediction Image Generating Portion 110

In the prediction image generating portion 110, the coding mode selecting portion 125 delivers coding mode information (129, 126) in order to obtain information about coding mode candidates for coding. This coding mode candidate is, for example, an intra coding mode in which coding is performed by using pixel information between frames, an inter coding mode in which coding is performed by using a correlation relationship among pixel information within a frame, or the like. Moreover, each coding mode includes a plurality of process methods that include methods of creating a prediction image thereof and patterns of dividing a frame to pieces. As the patterns of dividing a frame to pieces, for example, there is one including a plurality of patterns of rectangular areas of 16*16, 16*8, 8* 16, 8*8, 8*4, 4*8, 4*4, 4*2, 2*4, 2*2, 2*1, 1*2, 1*1 or another of dividing into shapes corresponding to a shape of an object.

Responding to each coding mode candidate, the coding mode selecting portion 125 acts as follows.

In the case of the intra coding mode, the coding mode selecting portion 125 first delivers image area designation information 130. The image area designation information 130 is information for designating an image area that is necessary for intra prediction among decoded image signals 115 that are already coded and stored in the image memory 122. The image memory 122 delivers the decoded image signal 115 of the designated area as the specific decoded image signal 124 to the coding mode selecting portion 125.

Next, the coding mode selecting portion 125 delivers the intra prediction coding mode information 129 to the intra prediction image generating portion 121. The intra prediction coding mode information 129 includes a method of generating the prediction image for performing intra prediction coding and an image signal that is necessary for the generating method.

The intra prediction image generating portion 121 generates the intra prediction information 128 in accordance with the input image signal 101 and the intra prediction coding mode information 129, and delivers the same to the coding mode selecting portion 125. The intra prediction information 128 includes an intra prediction image signal generated by the intra prediction image generating portion 121 and information of difference between the input image signal 101 and the intra prediction image signal. Here, the information of difference is information indicating a difference between the input image signal 101 and the intra prediction image signal, such as a sum of absolute values of differential signals between the input image signal 101 and the intra prediction image signal or a sum of squares of differential signals.

In the case of the inter coding mode, the coding mode selecting portion 125 first delivers the image area designation information 130 similarly to the intra coding mode. The image area designation information 130 is information for designating an image area that is necessary for inter prediction among decoded image signals 115 that are already coded and stored in the image memory 122. The image memory 122 delivers the decoded image signal of the designated area as the specific decoded image signal 124 to the coding mode selecting portion 125.

Next, the coding mode selecting portion 125 delivers the inter prediction coding mode information 126 to the inter prediction image generating portion 123. The inter prediction coding mode information 126 includes a method of generating the prediction image for performing inter prediction coding and an image signal that is necessary for generating the prediction image. For example, there are methods including a mode in which the decoded image signal 115 is used that is before the image signal to be coded in the display order, a mode in which the decoded image signal 115 is used that is after the image signal to be coded in the display order, and a mode in which both the decoded image signals 115 before and after the image signal to be coded are used. In each of the modes, the coding mode selecting portion 125 can use the image area designation information 130 for designating the corresponding decoded image, obtain the same as the specific decoded image signal 124, and deliver the same to the inter prediction image generating portion 123.

The input image signal 101 and the inter prediction coding mode information 126 are entered in the inter prediction image generating portion 123. On this occasion, it delivers the motion detecting image signal 112a for generating the prediction image corresponding to the inter prediction coding mode information 126 to the motion vector detecting portion 111.

Moreover, the first motion associated information 112b and the inter prediction coding mode information 126 are entered in the inter prediction image generating portion 123. The portion 123 generates the inter prediction information 127, and delivers the same to the coding mode selecting portion 125. Here, the inter prediction information 127 includes inter prediction image signal generated by using the first motion associated information 112b and the inter prediction coding mode information 126, and information of difference between the input image signal 101 and the inter prediction image signal. Here, the information of difference is information indicating a difference between the input image signal 101 and the inter prediction image signal, such as a sum of absolute values of differential signals between the input image signal 101 and the inter prediction image signal or a sum of squares of differential signals.

Motion Vector Detecting Portion 111

The motion vector detecting portion 111 detects a motion by using the entered motion detecting image signal 112a.

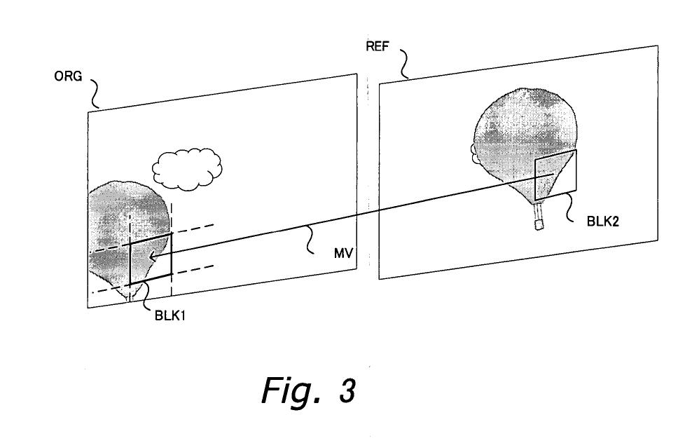

The operation of this motion vector detecting portion will be described in detail with reference to FIG. 3.

The input image frame ORG is a frame to be coded. A reference image frame REF is a frame that is already coded and decoded, and it is also an image frame at a different time from the input image frame ORG.

First, the input image frame ORG is divided into areas of coding units. For example, as shown in FIG. 3, it is possible to divide into rectangular areas. An input image block BLK1 is a unit area for coding.

In order to detect a motion between the input image frame ORG and the reference image frame REF, an area that is similar to the input image block BLK1 is searched from the reference image frame REF. As a criterion of deciding similarity in the search process, there is a sum of absolute values SAD of pixel differential information (a differential sum of absolute values) and a sum of squares SSE of pixel differential information (a differential sum of squares), for example. The reference image block BLK2 is an example of the block that is decided to be most similar. In this case, a motion vector MV indicates a position relationship between the input image block BLK1 and the reference image block BLK2.

The motion vector detecting portion 111 searches a motion vector in accordance with similarity between an area to be coded and an area to be referred. The motion vector detecting portion 111 delivers a result of motion detection as the first motion associated information 112b to the inter prediction image generating portion 123 and delivers the same as the second motion associated information 203 to the image quality deterioration prediction portion 201. Here, the first motion associated information 112b is information of the motion vector and information of the similarity that was used for the decision. The second motion associated information 203 is information of a motion vector. However, it may include information of similarity in the same manner as the first motion associated information 112b.

Image Quality Deterioration Prediction Portion 201

The image quality deterioration prediction portion 201 predicts possibility of deterioration in the decoded image quality when coding and decoding the input image signal 101 by the second motion associated information 203 that is an output of the motion vector detecting portion 111, and delivers the image quality deterioration prediction information 202.

The operation of the image quality deterioration prediction portion 201 will be described in more detail.

A motion vector to the input image signal 101 is obtained in accordance with the second motion associated information 203. Next, a difference degree between a motion vector and surrounding motion vectors is checked. Here, the difference degree is a variance, a sum of squares of differentials, a sum of absolute values of differentials or the like of motion vectors within a certain area. In addition, these values may be calculated with weights consisting corresponding to a distance from an object motion vector. If this difference degree is large, it can be decided there is high possibility of occurring deterioration in image quality. Therefore, this difference degree is delivered as the image quality deterioration prediction information 202.

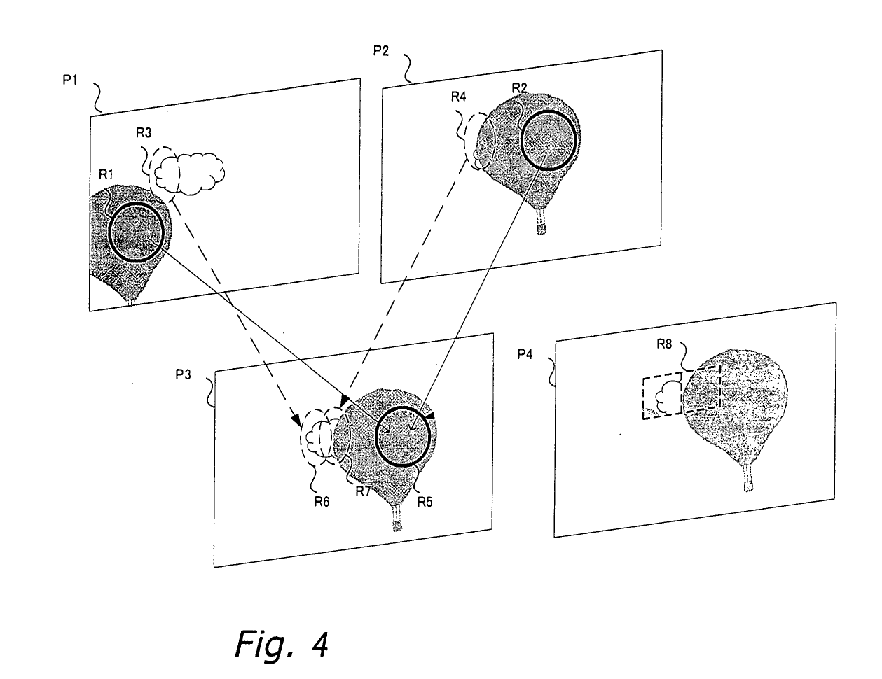

A prediction of deterioration in image quality in accordance with the difference degree will be described with reference to FIG. 4.

FIG. 4 shows the case where the motion vector detecting portion 111 performs the motion detection on the input image signal 101 in display order using decoded image signal 115 of the forward direction and the backward direction as the reference images.

P1 and P2 are reference image frames in the motion vector detecting portion 111, P3 is the input image frame to be coded, and P4 is an inter prediction image frame generated by an inter prediction generating portion. R1, R2, R3 and R4 are reference areas, while R5, R6 and R7 are motion detection target areas within the input image frame. In addition, R8 is a motion compensation area that is generated in accordance with the result of motion detection. A display order of images is the display order of P1, P3 and P2.

The motion vector detecting portion 111 searches an area having high similarity to the motion detection target areas R5, R6 and R7 within the reference image frames P1 and P2. The reference area R3 is detected as the area having high similarity for the motion detection target area R5, the reference area R4 is detected as the area having high similarity for the motion detection target area R6 and the reference areas R1 and R2 are detected as the area having high similarity for the motion detection target area R7.

In accordance with these motion vectors, the inter prediction image generating portion 123 generates the inter prediction image frame P4. The motion compensation area R8 in the inter prediction image frame P4 includes an area that is different from the input image frame P3, i.e., an area for which the prediction was failed. This is because that the reference area R3 corresponding to the motion detection target area R6 includes an area different from the area R6, and further the reference area R4 corresponding to the motion detection target area R7 includes and area different from the area R7. Thus, it is determined that the areas R6 and R7 have different motions from each other. As each area includes another area having a different motion, an area that is different from the input image frame is generated within the motion compensation area R8. As the motion compensation area R8 is an area for which the inter prediction was failed, there is high possibility of occurrence of distortion in coding.

In contrast, concerning the motion detection target area R5, the prediction was not failed within the inter prediction image frame. This is because that the reference areas R1 and R2 corresponding to the motion detection target area R5 act similarly to surrounding areas, so that motion compensation can be performed only in the areas that act in the same manner.

Thus, it is possible to decide whether an action of an area is the same as or different from surrounding areas by calculating the difference degree, so that occurrence of image quality deterioration can be predicted.

Coding mode selection process in the coding mode selecting portion 125 Next, a process in the coding mode selecting portion 125 will be described in detail.

The coding mode selecting portion 125 delivers candidate coding mode information of the intra prediction coding mode and the inter prediction coding mode, so as to obtain the intra prediction information 128, the inter prediction information 127, the code quantity information 119 and the image quality deterioration prediction information 202 in each candidate coding mode. The code quantity information 119 is code quantity when once coding and decoding in the candidate coding mode.

The coding mode selecting portion 125 calculates decision criterion J in accordance with code quantity R generated in a plurality of candidate coding modes, a difference D between the decoded image signal 115 and the input image signal 101, and a degree of image quality deterioration a obtained from the image quality deterioration prediction information 202, so as to determine a coding mode that is used for coding from a plurality of candidate coding modes.

The decision criterion J can be expressed by the following equation (1).
J=α×D+λR (hereinafter referred to as an equation (1)).

The coding mode selecting portion 125 selects a candidate coding mode having the smallest decision criterion J as a coding mode for coding.

Here, λ, R, D and α in the equation (1) will be described in more detail.

Reference λ is a variable that is determined by accuracy of quantization. The value of λ may be determined in accordance with accuracy of quantization determined by the quantization control portion 116 as being described later. λ may be a constant value in order to reduce the circuit size.

The generated code quantity R is code quantity information 119. Here, the generated code quantity R is not necessarily the code quantity information 119 when coding once. In this case, a value that is estimated from the intra prediction information 128 and the inter prediction information 127 can be used. For example, code quantity that will be generated is estimated from a motion vector of the inter prediction information 127 and a value indicating similarity. In addition, the code quantity that will be generated is estimated from differential value information of the intra prediction information 128 and the coding mode information. Thus, it is not necessary to perform coding once so that the process can be simplified.

Reference D that indicates a difference between the decoded image and the input image is similarity information between the differential value information of the intra prediction information 128 and the inter prediction information 127. Here, D that indicates a difference between the decoded image and the input image may be a differential value between the decoded image and the input image in the case where coding is performed once. In this case, distortion in the coding mode can be evaluated correctly, so that accuracy of the coding mode selection can be raised.

The degree of image quality deterioration a is a value that is obtained from the image quality deterioration prediction information 202. More specifically, the degree of image quality deterioration a has a value that is substantially the same as the image quality deterioration prediction information 202 or a value that increases simply along with a value of the image quality deterioration prediction information 202. Namely, the degree of image quality deterioration a becomes large value as possibility of image quality deterioration becomes large.

The following effect can be obtained by the process using the decision criterion J.

If there is a low possibility of image quality deterioration, the degree of image quality deterioration a has a small value. For this reason, an influence of D that indicates a difference between the decoded image and the input image to the decision criterion J becomes small, while an influence of the generated code quantity R becomes large. For this reason, even if the decoded image is different from the input image, a coding mode having a small generated code quantity R is selected. This causes regarding it more important to suppress the generated code quantity than difference from the input image in a part having a low possibility of image quality deterioration. Thus, code quantity can be reduced in an area having a low possibility of occurrence of image quality deterioration within the decoded image.

In contrast, if there is a large possibility of image quality deterioration, the degree of image quality deterioration a has a large value. Therefore, the influence of D that indicates a difference between the decoded image and the input image to the decision criterion J becomes large, while the influence of the generated code quantity R becomes small. For this reason, even if the generated code quantity R is small, a coding mode in which the decoded image is similar to the input image is selected. This causes regarding it more important to perform coding so that the coded image becomes similar to the input image than to suppress code quantity in a part having a high possibility of image quality deterioration. Thus, image quality in an area having a high possibility of occurrence of image quality deterioration within the decoded image can be improved.

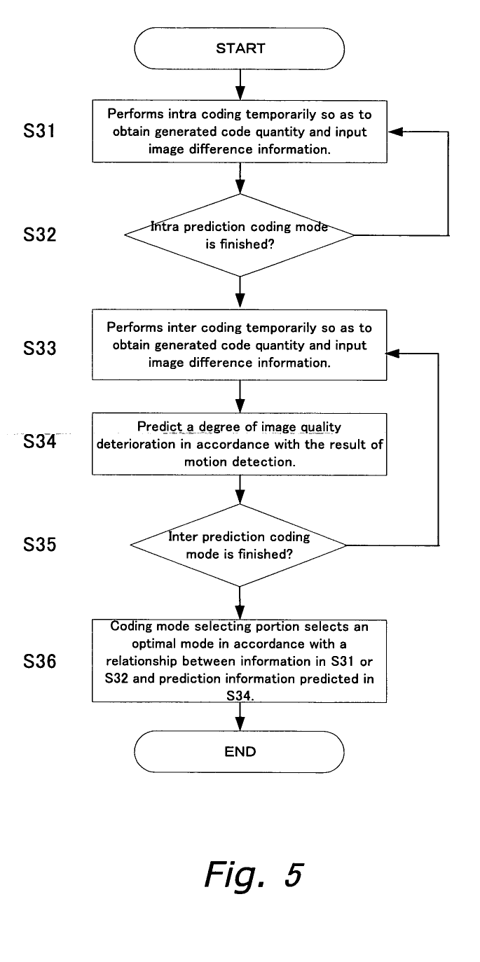

A procedure in the process of the coding mode selecting portion 125 is shown in FIG. 5.

In S31, the coding mode selecting portion 125 performs the intra coding temporarily, so as to obtain the generated code quantity and difference information between the decoded image signal 115 and the input image signal 101. Next in S32, if there is another candidate coding mode for the intra prediction, S31 is repeated. If there is no other candidate coding mode, the motion detection and the inter coding are performed temporarily in the inter coding mode in S33, so as to obtain the generated code quantity and the difference information between the decoded image signal 115 and the input image signal 101. Next in S34, a degree of image quality deterioration is predicted in accordance with the result of motion detection obtained in S33. In S35, if there is another candidate coding mode for the inter prediction, S33 and S34 are repeated. If there is no other candidate coding mode, a coding mode is determined in accordance with the decision criterion J shown in the equation (1) in S35.

Operations in other Portions

A differential signal, obtained by subtraction between the input image signal 101 and the prediction image signal 113 generated by the prediction image generating portion 110, is entered in the orthogonal transformation portion 103. The orthogonal transformation portion 103 transforms the differential signal into frequency components. As a method of this transformation, a discrete cosine transformation (DCT) or the like can be used, for example. Coefficient information after the orthogonal transformation performed by the orthogonal transformation portion 103 is entered in the quantizing portion 104.

The quantizing portion 104 quantizes the coefficient information after the orthogonal transformation. On this occasion, accuracy of quantization is changed by the quantization control signal 117 from the quantization control portion 116. Here, a method of determining the accuracy of quantization will be described later. The information quantized by the quantizing portion 104 is entered together with the accuracy of quantization in the variable length coding portion 105. Note that the accuracy of quantization may be added for each unit of coding. For example, it may be information that is added for each block (each macro block).

The variable length coding portion 105 performs variable length coding on the quantized information. The variable length coding is a method for compressing information utilizing entropy of information. In addition , the variable length coding portion 105 performs the variable length coding also on the coding mode associated information 114 obtained by the prediction image generating portion 110. The coded stream 106 coded by the variable length coding portion 105 is entered in the code quantity counter 118.

The code quantity counter 118 counts code quantity of the coded stream 106 and delivers the same as the code quantity information 119. The code quantity information 119 is entered in the quantization control portion 116 and the prediction image generating portion 110.

The quantization control portion 116 determines accuracy of quantization for coding of the next image frame in accordance with the code quantity information 119.

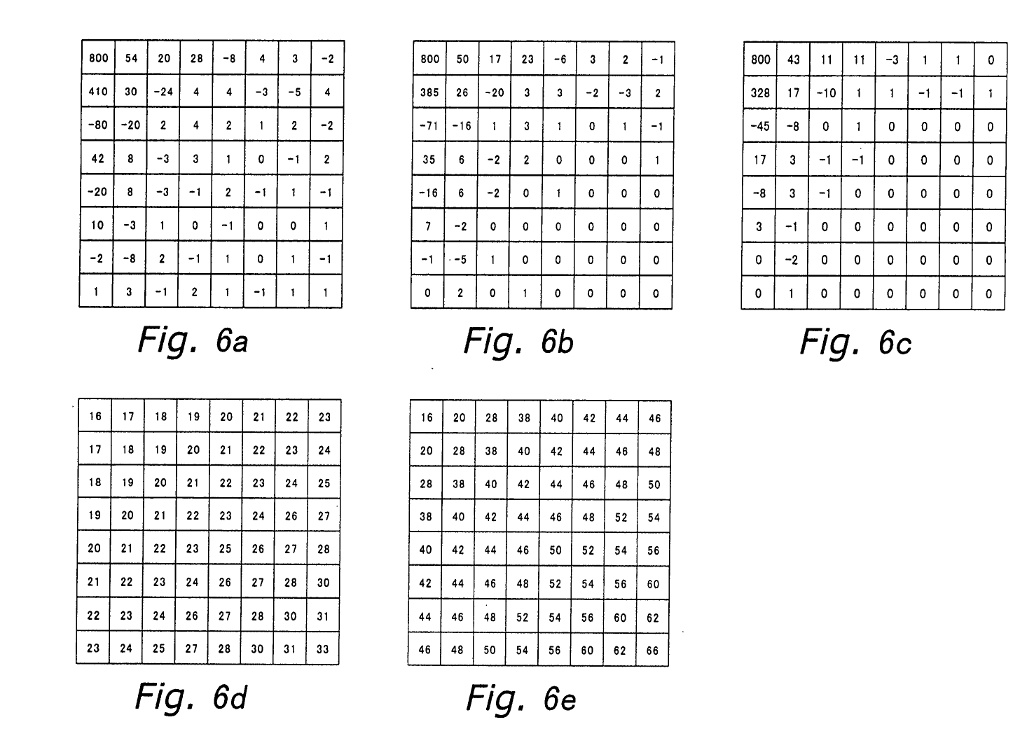

On this occasion, the quantization control portion 116 may perform modulation of the coefficient information after the orthogonal transformation. The modulation of the coefficient information will be described in detail with reference to FIG. 6.

The coefficient information after the orthogonal transformation performed by the orthogonal transformation portion 103 is modulated in accordance with the operational equation expressed by the following equation (2).
Q′(x, y)=Q(x, y)×16/M(x,y) (hereinafter referred to as equation (2))

In the equation (2), an original transformed coefficient is represented by Q(x, y), a modulation degree is represented by M(x, y), and the coefficient after modulation is represented by Q′(x, y). In addition , x represents a position in the x axis direction, while y represents a position in the y axis direction.

For example, if the modulation degree shown in FIG. 6(d) is used for the original transformed coefficient Q(x, y) (see FIG. 6(a)), a result of the modulation is as shown in FIG. 6(b). In addition, if the modulation degree shown in FIG. 6(e) is used, a result of the modulation is as shown in FIG. 6(c). The coefficient shown in FIG. 6(a) shows DC component at the upper left corner and high frequency components increases toward the lower right corner.

Here, when the modulation shown in the equation (2) is performed, information of high frequency components can be reduced so that generated code quantity can be controlled. For example, it is understood that more high frequency components can be reduced by the modulation degree shown in FIG. 6(e) than by the modulation degree shown in FIG. 6(d).

Note that it is possible to control the modulation degree shown in FIGS. 6(d) and 6(e) by the image quality deterioration prediction information 202. If there is a high possibility of the image quality deterioration according to the image quality deterioration prediction information 202, the modulation is not performed or M(x, y) having a small modulation degree is selected (for example, FIG. 6(d)). If there is a low possibility of the image quality deterioration, M(x, y) having a large modulation degree is selected (for example, FIG. 6(e)). Otherwise, all values of Q′(x, y) are set to zero. Namely, all the transformed coefficients are set to zero.

Thus, if the image quality deterioration is apt to occur, reduction of the coefficients is not performed so much so as to maintain image quality. In addition, if image quality deterioration is not apt to occur, many coefficients are reduced so as that generated code quantity can be reduced.

Note that information of the modulation degree that was used in the quantization control portion 116 (for example, a table shown in FIG. 6(d) or 6(e)) may be predicted in the decoding side from the image quality deterioration prediction information (see the second embodiment). Otherwise, it may be delivered from the quantization control portion 116 via the quantizing portion 104 and coded in variable length by the variable length coding portion 105 together with the quantized information by the quantizing portion 104 and accuracy of quantization. On this occasion, the information of the modulation degree that is coded in variable length may be information of a table form shown in FIG. 6(d) or 6(e). Otherwise, if there is a plurality of predetermined tables prepared, it may be information for one of the tables.

In addition, the case where quantization control portion 116 determines accuracy of quantization will be described.

The quantization control portion 116 checks generated code quantity in accordance with the code quantity information 119 and switches accuracy of quantization so that code quantity of the coded stream becomes a target value. For example, if generated code quantity is larger than the target value, accuracy of quantization is decreased. In contrast, if the generated code quantity is smaller than the target value, accuracy of quantization is increased. Here, “accuracy of quantization is decreased” means the quantization is performed under a low bit rate, and “accuracy of quantization is increased” means the quantization is performed under a high bit rate.

On this occasion, it is possible to change the method of switching accuracy of quantization in accordance with the image quality deterioration prediction information 202. In this case, if image quality deterioration is apt to occur according to the image quality deterioration prediction information 202, accuracy of quantization is increased. Thus, occurrence of distortion can be suppressed, so that image quality can be improved. In addition, if image quality deterioration is not apt to occur, accuracy of quantization is decreased. Thus, generated code quantity can be reduced.

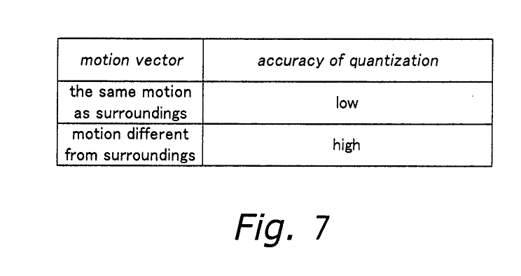

In this case, a relationship between a motion vector of the input image signal 101 (second motion associated information 203) and accuracy of quantization is as shown in FIG. 7. Namely, if the image quality deterioration prediction information 202 is large, namely, if a difference degree between a motion vector of the block or the like to be processed and a motion vector of the surrounding block is large (if the block to be processed has a different motion from the surrounding blocks), the quantization is performed at high accuracy of quantization. In contrast, if a difference degree between motion vectors is small (if the block to be processed has the same motion), the quantization is performed at low accuracy of quantization. Note that “surrounding” does not always mean all the portions surrounding an object but may mean just a vicinity of the object.

The inverse quantization portion 107 performs inverse quantization on the information quantized by the quantizing portion 104. On this occasion, the quantization control signal 117 performed by the quantization control portion 116 is also entered. The inverse quantization portion 107 performs inverse transformation by utilizing the quantization control signal 117 so as to generate coefficient information.

The inverse orthogonal transformation portion 108 obtains differential information by performing inverse orthogonal transformation on the coefficient information after the inverse transformation. The operating portion 109 adds the differential information to the prediction image signal 113 so as to obtain the decoded image signal 115.

The process described above may be performed for each unit of coding, each block or each macro block, or performed for each picture unit, for example.

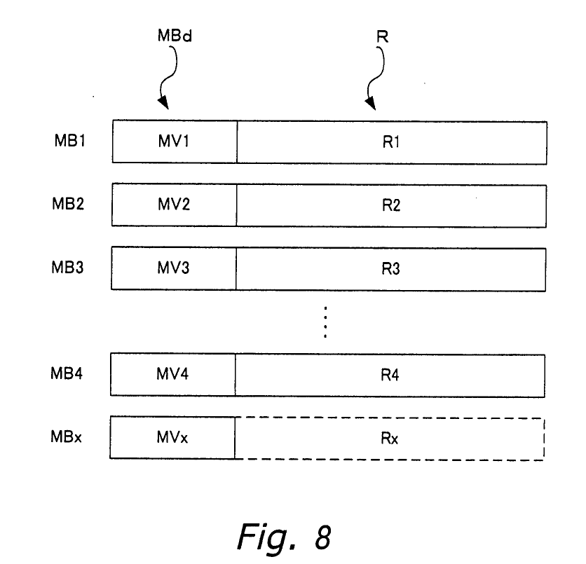

With reference to FIG. 8, data structure of the coded stream 106 that is delivered from the coding device 100 shown in the above embodiments will be further described.

FIG. 8 shows a data structure of a macro block layer among data included in the coded stream 106. The coded stream 106 includes a moving image stream that has a hierarchical structure, which includes a sequence layer, a GOP layer, a picture layer, a slice layer, a macro block layer and a block layer, for example. Note that the structure described here is an example and does not mean that the present invention is limited to this structure.

The macro block layer includes a macro block data MBd that includes a motion vector MV of each macro block and quantized information indicating accuracy of quantization, and differential information R that is data of each block.

FIG. 8 shows that macro blocks MB1-MBx include motion vectors MV1-MVx as the macro block data and differential information R1-Rx, respectively.

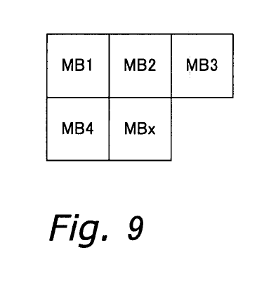

Here, the macro block MBx is regarded as a macro block to be processed, and the macro blocks MB1-MB4 are regarded as macro blocks surrounding the macro block MBx. A position relationship between the macro block MBx and each of the macro blocks MB1-MB4 is as shown in FIG. 9, for example. The macro blocks MB1-MB4 are disposed at the upper left position, the upper position, the upper right position and the left position of the macro block MBx, respectively.

As described in above embodiment, when the process is performed on the macro block MBx to be processed, the image quality deterioration prediction information is determined. The macro blocks MB1-MB4 is supposed to be a macro block that is used for determining this image quality deterioration prediction information. Namely, if the image quality deterioration prediction information is determined for the macro block MBx, the difference degree between the motion vector MVx and each of motion vectors MV1-MV4 is determined.

Moreover, differential information Rx is information of a quantized and coded differential image between an original and a prediction image, and Rx is obtained by controlling quantization in accordance with image quality deterioration prediction information. More specifically, if the image quality deterioration prediction information determined for the macro block MBx is large (image quality deterioration is apt to occur), the accuracy of quantization is increased, or coefficient modulation is performed with a smaller modulation degree (for example, a modulation without reducing higher frequency components) so that the quantization is performed. In contrast, if the image quality deterioration prediction information determined for the macro block MBx is small (image quality deterioration is not apt to occur), the accuracy of quantization is decreased, or the coefficient modulation is performed with a larger modulation degree (for example, a modulation with reducing higher frequency components) so that the quantization is performed. Therefore, the code quantity of the differential information Rx depends on a size of image quality deterioration prediction information. The larger the image quality deterioration prediction information is, the larger the generated code quantity becomes. The smaller the image quality deterioration prediction information is, the smaller the generated code quantity becomes.

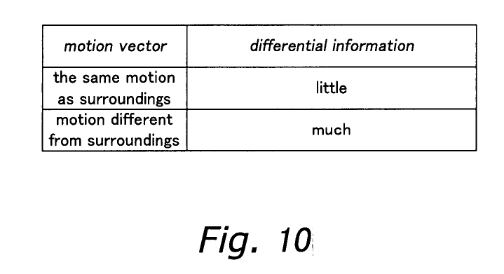

Therefore, the data structure shown in FIG. 8 has a feature as shown in FIG. 10. Namely, the code quantity of the differential information Rx of the macro block MBx depends on the difference degree between the motion vector MVx and each of the motion vectors MV1-MV4. In other words, the code quantity of the differential information (Rx, for example) of the macro block (MBx, for example) to be processed is larger as the difference degree between each of the motion vectors (MV1-MV4, for example) of the surrounding macro blocks (MB1-MB4, for example) and the motion vector (MVx, for example) of the macro block to be processed is larger, and it is smaller as the same is smaller.

In addition, a value of the quantized information in the macro block data of the macro block to be processed indicates higher accuracy of quantization as the difference degree between each of the motion vectors of the surrounding macro blocks and the motion vector of the macro block to be processed is larger, and it indicates lower accuracy of quantization as the same is smaller.

Note that although the coded macro blocks MB1-MB4 of the macro block MBx to be processed are regarded as surrounding macro blocks as an example in the above description, how to adopt the surrounding macro blocks is not limited to this. For example, it is possible to use a coded macro block of a wider area. In addition, it is possible to determine motion information temporarily so that all macro blocks surrounding the macro block MBx are regarded as the surrounding motion information.

In this case, using wide range of motion information, control performance of the differential information Rx can be improved, and the image quality can be improved.

Note that although all the macro blocks include the motion vector MV and the differential information R in FIG. 8, it is not always necessary that all the macro blocks include the motion vector MV and the differential information R.

For example, if the coding mode of a macro block is a direct mode, the structure of the coded stream does not include a motion vector. In this case, it is possible to use a motion vector that is generated by a predetermined method as surrounding motion vectors. Note that the direct mode is a method in which a motion vector is generated by a predetermined method even in the inter coding so that a motion vector is not sent.

In addition, if the coding mode of a macro block is an intra mode for example, the structure of the coded stream does not include motion vector. In this case, it is possible to determine a difference to surrounding motions by a predetermined method. More specifically, if there are a constant number or more (a half or more, for example) of intra prediction coding mode macro blocks around the macro block to be processed for example, it is determined that the motion of the macro block to be processed is different from the motion of surrounding macro blocks. On the contrary, if the number of intra prediction coding mode macro blocks is less than a constant number, a difference to surrounding motions, in which intra prediction coding mode macro blocks are eliminated, is used. Or a difference to surrounding motion, in which motion of intra prediction coding mode macro blocks are assumed to be 0, is used.

In addition, it is possible that a certain macro block does not include a differential information R, for example.

First Modification of the First Embodiment

The following modification can be considered within the practical range of the first embodiment.

It is possible to determine an optimal modulated coefficient degree when an optimal coding mode is selected in the process of the coding mode selecting portion 125.

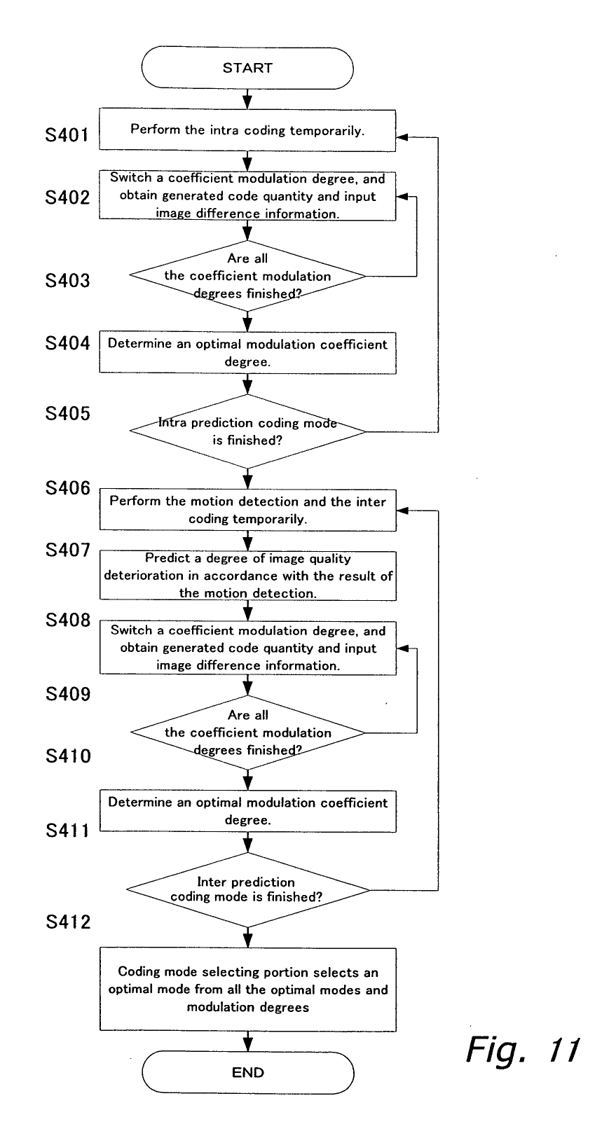

This will be described in detail with reference to FIG. 11.

The coding mode selecting portion 125 performs the intra coding temporarily in S401, switches a coefficient modulation degree for the intra coding in S402, and obtains generated code quantity and input image difference information. As shown in S403, a plurality of coefficient modulation degrees is prepared, and the generated code quantity and the input image difference information are obtained for each of the coefficient modulation degrees.

In S404, the coefficient modulation degree corresponding to the optimal decision criterion is determined. As this decision criterion, the equation (1) is used. However, in the case of the intra coding, a value of a that indicates a degree of image quality deterioration is not decided. In this case, a value of a can be a fixed value. In addition, a value of a may be calculated in accordance with the motion vector when inter coding is performed before and after in the display order. The motions before and after the moving image have a correlation, so the image quality deterioration prediction can be performed even in the intra coding. Thus, image quality can be maintained, and reduction of the code quantity can be realized. Moreover, the coefficient modulation degree of the least value expressed in the equation (1) can be maintained.

In S405, the process from S401 to S404 is repeated for all the intra coding modes.

In S406, the motion detection and the inter coding are performed temporarily. In S407, the degree of image quality deterioration is predicted in accordance with the result of motion detection. In S408, the coefficient modulation degree for the inter coding is switched, and the generated code quantity and the input image difference information are obtained. In S409, the coefficient modulation degree is switched, and the generated code quantity and the input image difference information of each are obtained in the same manner as in S403.

In S410, the coefficient modulation degree is determined in the same manner as in S404. As the decision criterion in this case, the equation (1) is used. The coefficient modulation degree of the least value expressed in the equation (1) is maintained.

In S411, the process from S406 to S410 is repeated for all the intra coding modes.

In S412, from among all the coding modes and modulation degrees calculated in the process from S401 to S411, an optimal one, namely one having the small decision criterion of the equation (1) is selected as the coding mode.

By performing this coding mode selection, the modulated coefficient degree and the coding mode selection can be select optimally, so that improvement of the image quality and reduction of the code quantity can be realized.

In this case, the coefficient modulation degree determined by the coding mode selecting portion 125 may be included in the coding mode associated information 114 and is entered in the variable length coding portion 105, which performs the variable length coding. On this occasion, information of the modulation degree that is coded with a variable length may be information having a table format. Otherwise, if a plurality of predetermined table is determined, it may be information for specifying any one of them.

Second Modification of the First Embodiment

The following modification can be considered within the practical range of the first embodiment.

The image quality deterioration prediction information 202 may not be used for the quantization control. The image quality deterioration prediction information 202 may be one that is used only by the coding mode selecting portion 125. In this way, reduction of a circuit scale and reduction of process quantity can be realized.

Third Modification of the First Embodiment

The following modification can be considered within the practical range of the first embodiment.

The image quality deterioration prediction information 202 may not be used for the coding mode selection. The image quality deterioration prediction information 202 may be one that is used only by the quantization control portion 116. In this way, reduction of a circuit scale and reduction of process quantity can be realized.

Fourth Modification of the First Embodiment

In the above embodiment, it is possible to switch whether or not the process described in the above embodiment is performed in accordance with a value that is a coded stream target of the code quantity.

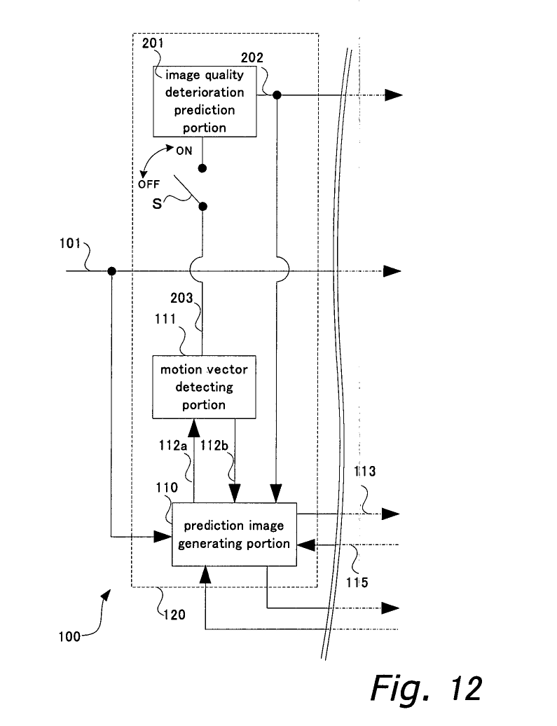

A switch S for realizing this switching is disposed between the motion vector detecting portion 111 and the image quality deterioration prediction portion 201 in the coding device 100 (see FIG. 1) as shown in FIG. 12.

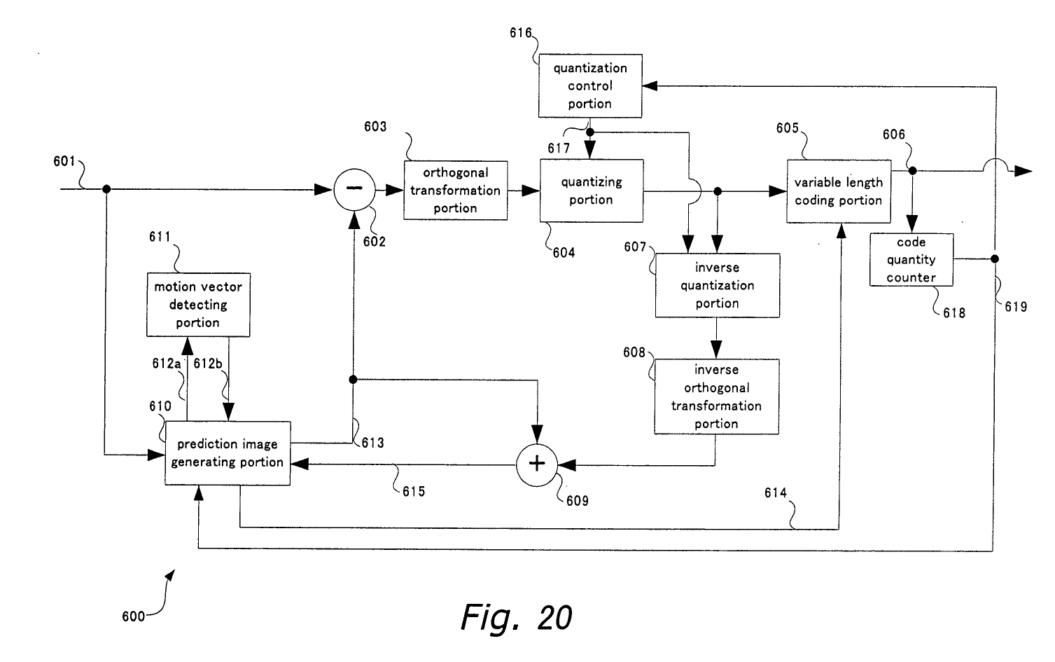

Moreover, the switch S is directed to OFF side when the code quantity of the target is high, while it is directed to ON side when the code quantity of the target is low. Thus, when the code quantity of the target is high, the coding device 100 having the switch S works in the same way as the conventional coding device 600 described above with reference to FIG. 20, while it works in the same way as the coding device 100 described in the above embodiment when the code quantity of the target is low. Note that the code quantity of the target may be one that is set externally by using a setting portion (not shown) or the like.

Thus, if the code quantity of the target is high, image quality that is equal to the conventional one can be obtained. In contrast, if the code quantity of the target is low, image quality deterioration can be suppressed so that image quality that is better than before can be obtained.

In addition, information showing condition of a switch S can be coded. Thus, when decoding, action corresponding to the condition of the switch S is possible, so that image quality that is better than before can be obtained.

Second Embodiment

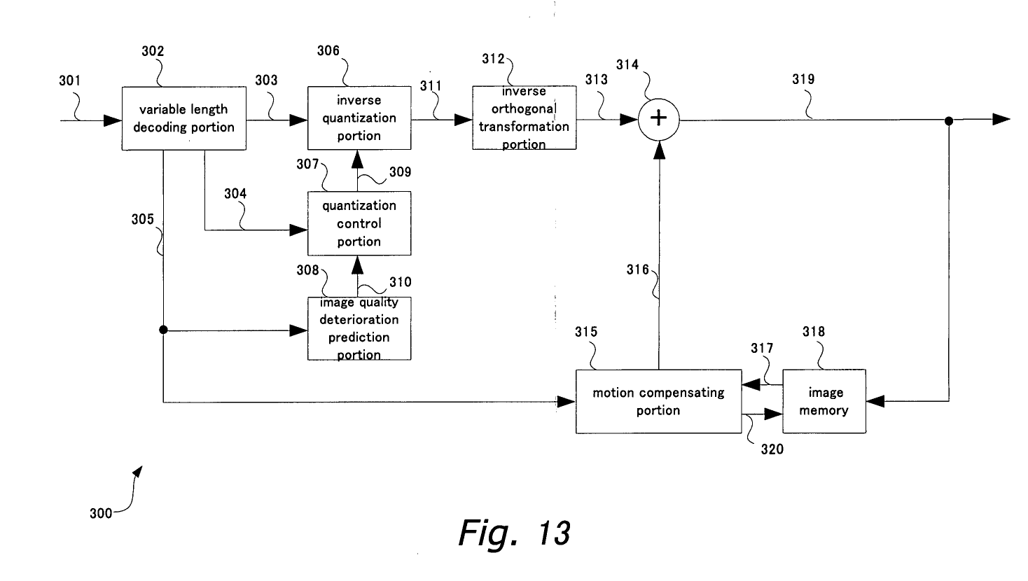

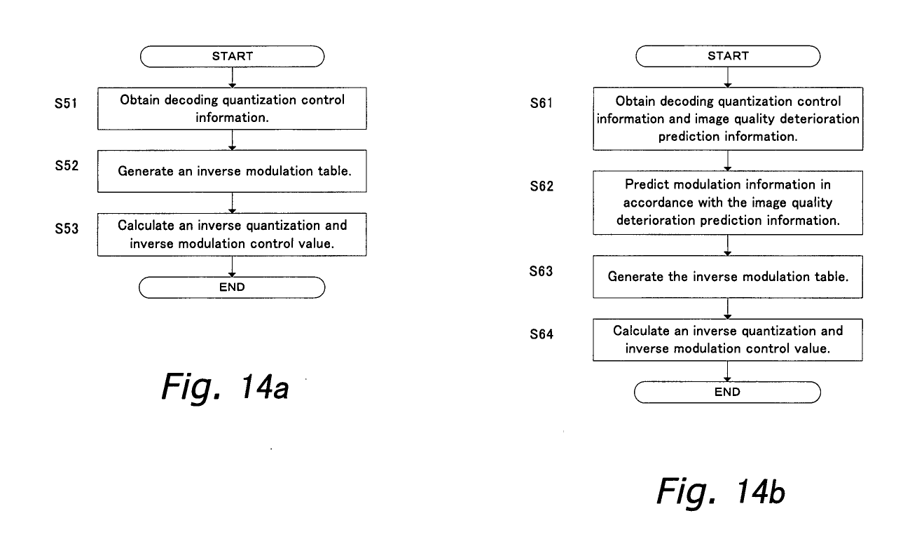

With reference to FIGS. 13-14, a moving image decoding device (hereinafter referred to as a decoding device) as a second embodiment of the present invention will be described.

Note that the decoding device of this embodiment can be used for decoding not only a coded stream that is coded by the coding device 100 described in the first embodiment but also a coded stream that is coded by the conventional coding device. Namely, it has a compatibility with the conventional coding device. Therefore, the expression “coding device” in the following description does not mean only the coding device 100.

Structure

FIG. 13 is a block diagram showing a structure of a decoding device 300.

A coded stream 301 is entered in a variable length decoding portion 302, and the portion 302 delivers decoding coefficient information 303, decoding quantization control information 304 and motion associated information 305. The decoding coefficient information 303 and quantization control information 309 are entered in an inverse quantization portion 306, and the portion 306 delivers coefficient information 311. The decoding quantization control information 304 and image quality deterioration prediction information 310 are entered in a quantization control portion 307, and the portion 307 delivers the quantization control information 309. The motion associated information 305 is entered in an image quality deterioration prediction portion 308, and the portion 308 delivers the image quality deterioration prediction information 310. The coefficient information 311 is entered in an inverse orthogonal transformation portion 312, and the portion 312 delivers a differential image signal 313. The differential image signal 313 and a motion compensation image signal 316 are entered in an operating portion 314, and the portion 314 delivers a decoded image signal 319. The motion associated information 305 and a specific decoded image signal 317 are entered in a motion compensating portion 315, and the portion 315 delivers the motion compensation image signal 316 and image area designation information 320. The decoded image signal 319 and the image area designation information 320 are entered in an image memory 318, and the image memory 312 delivers the specific decoded image signal 317.

Operation

Next, the operation of the decoding device 300 will be described.

The variable length decoding portion 302 decodes the coded stream 301 in variable length and delivers the decoding coefficient information 303, the decoding quantization control information 304 and the motion associated information 305 independently.

The decoding coefficient information 303 is obtained by performing orthogonal transformation and quantization on the differential signal by the coding device. The decoding quantization control information 304 includes a mode and a value that were used by the coding device for modulating accuracy and coefficient of the quantization. The motion associated information 305 is information of the motion vector that was used by the coding device for motion compensation in the inter prediction coding mode.

The image quality deterioration prediction portion 308 predicts the image quality deterioration in accordance with the motion associated information 305. A method for predicting the image quality deterioration is the same as described in the first embodiment. The image quality deterioration prediction portion 308 calculates possibility of occurrence of the image quality deterioration and delivers it as the image quality deterioration prediction information 310 to the quantization control portion 307. The image quality deterioration prediction portion 308 generates the image quality deterioration prediction information 310 in accordance with the motion associated information 305 that is used for decoding, so it is not necessary to code the image quality deterioration prediction information 310 by the coding device.

The quantization control portion 307 generates the quantization control information 309 in accordance with the image quality deterioration prediction information 310 and the decoding quantization control information 304. The operational means in this case will be described in detail with reference to FIG. 14.

In the case of the coding mode that does not include the motion associated information 305, the procedure is as follows. As shown in FIG. 14(a) , the decoding quantization control information 304 is obtained in S51 in the same manner as the conventional method, and an inverse modulation table is generated from information included in it in S52. Then, in S53, an inverse modulation control value including quantization accuracy information and the inverse modulation table for the inverse quantization is calculated, and the quantization control information 309 is generated.

The inverse modulation table is a table for multiplying an inverse value for getting the modulation value shown in FIG. 6(d) or 6(e) and the equation (2) back to the original (it is the same in the following description).

In addition, the case of the coding mode that includes the motion associated information 305, the procedure is as follows. As shown in FIG. 14(b), the decoding quantization control information 304 and the image quality deterioration prediction information 310 are obtained in S61, a modulation information is predicted in accordance with the image quality deterioration prediction information 310 in S62, the inverse modulation table is generated from the predicted modulation information in S63, the inverse modulation control value including the quantization accuracy information and the inverse modulation table for the inverse quantization is calculated in S64, and the quantization control information 309 is generated.

As methods for predicting modulation information from image quality deterioration prediction information 310, there is adopted methods for keeping a table of predetermined image quality deterioration prediction information and the modulation degree.

In addition, even in the case of the coding mode that does not include the motion associated information 305, it is possible to use the methods shown in FIG. 14(b) In this case, the image quality deterioration prediction information 310 is obtained by interpolating using motion associated information of neighboring areas in the decoded image. In this way, the code quantity for coding can be reduced, and further the image quality of decoding can be improved.

As described above, by using the inverse modulation table, the decoding device 300 performs the process for increasing high frequency components in the differential image signal 313, so that the image quality of decoding can be improved.

The inverse quantization portion 306 performs inverse quantization on the decoding coefficient information 303 by using the quantization control information 309, so as to obtain the differential image signal 313. The motion compensating portion 315 obtains the motion associated information 305 and delivers the image area designation information 320 to the image memory 318 so as to obtain the specific decoded image signal 317. Moreover, the motion compensating portion 315 uses the motion associated information 305 and the specific decoded image signal 317 for generating the motion compensation image, so as to deliver the motion compensation image signal 316. The operating portion 314 adds the differential image signal 313 to the motion compensation image signal 316 so as to deliver the decoded image signal 319. The decoded image signal 319 is entered in the image memory 318, and the image memory 318 accumulates the same. Therefore, when receiving the image area designation information 320, the designated specific decoded image signal 317 from among the accumulated decoded image signals 319 is delivered to the motion compensating portion 315.

First Modification of the Second Embodiment

The following modification can be considered within the practical range of the second embodiment.

It is possible to determine a range of using the methods shown in FIG. 14(b) in accordance with the image quality deterioration prediction information 310 that is predicted by the image quality deterioration prediction portion 308.

For example, the methods shown in FIG. 14(b) may be used in the case where the decoded image signal 319 that is accumulated in the image memory 318 and the decoded image signal 319 that is screen displayed are prepared separately and in the case where the decoded image signal 319 for the screen display is delivered, while the methods shown in FIG. 14(a) may be used in the case where the decoded image signal 319 that is accumulated in the image memory 318 is delivered.

In this case, even if accuracy of the image quality deterioration prediction is low, it affects only one frame of the screen display and does not affect the decoded image signal in the image memory 318 that is used for decoding the next frame.

In contrast, in the case of the coded stream that is coded on the precondition that the image quality deterioration prediction is performed on the coding side, there is a possibility that the motion compensation image signal predicted on the coding side is different from the motion compensation image signal 316 that is obtained from the motion compensating portion 315 on the decoding side, resulting in a bad influence to the decoded image signal of the next frame.

In this case, the methods shown in FIG. 14(a) may be used when the decoded image signal 319 for the screen display is delivered, while the methods shown in FIG. 14(b) may be used when the decoded image signal 319 that is accumulated in the image memory 318 is delivered. Thus, the image quality of the decoded image signal of the next frame can be improved.

Note that the methods shown in FIG. 14(b) may be used for both the decoding signal for the screen display and the decoding signal for image memory accumulation.

In this case, it is possible to generate the decoded image signal at one time so that the process quantity can be reduced.

In addition, it is possible to send information that indicates whether or not the image quality deterioration prediction was performed for coding as additional information. If the coded information includes additional information showing whether the image quality deterioration prediction is performed or not, action corresponding to the additional information is performed.

In this case, it is possible to determine which should be used for decoding, the methods shown in FIG. 14(a) or the methods shown in FIG. 14(b), in accordance with the additional information. Thus, the decoded image quality can be improved. For example, in the case that the above-mentioned process is not suitable, the process is not performed when the image quality deterioration prediction is not applied during the coding, and the decoded image quality can be improved

In addition, if deterioration of the image quality is predicted by the image quality deterioration prediction information 310, a smoothing filter may be adopted to the area of the decoded image in which the deterioration of the image quality is predicted.

Thus, an appropriate smoothing filter is adopted for the decoded image, so that the decoded image quality can be improved.

Second Modification of the Second Embodiment

Although it was described in the above embodiment that the modulation degree is generated from the image quality deterioration prediction information 310 (for example, by referring a table that links the image quality deterioration prediction information 310 with the modulation degree), it is possible to obtain the modulation degree from the decoding quantization control information 304 that includes the modulation degree if the modulation degree is coded.

Third Embodiment

By recording a program for realizing the moving image coding method or the moving image decoding method shown in the above-described embodiments in a recording medium such as a flexible disk, it is possible to readily perform the processes shown in the above-described embodiments in an independent computer system.

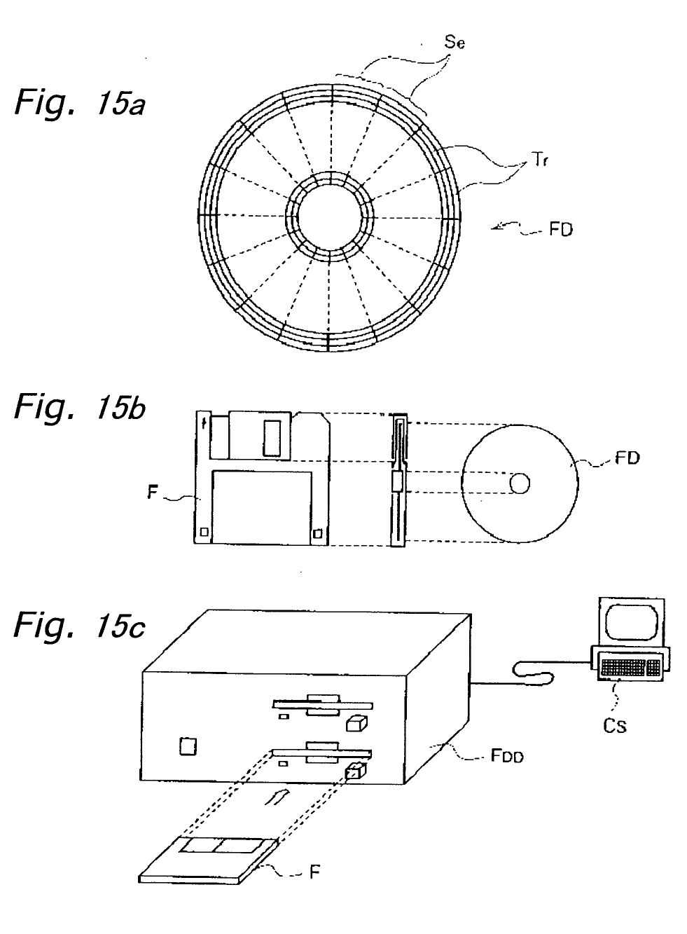

FIG. 15 is a diagram illustrating a case where the moving image coding method or the moving image decoding method according to the above-described embodiments is performed by a computer system using a program recorded in a recording medium such as a flexible disk.

FIG. 15(b) shows the appearance of a flexible disk viewed from the front, the cross-sectional structure and the flexible disk, and FIG. 15(a) shows an example of a physical format of the flexible disk serving as a recording medium body. A flexible disk FD is contained in a case F, and a plurality of tracks Tr are formed concentrically from the outer periphery to the inner periphery on the surface of the disk, with each track divided into 16 sectors Se in an angular direction. Therefore, in a flexible disk storing the above-described program, the program is recorded in an area allocated on the flexible disk FD.

Additionally, FIG. 15(c) shows a configuration for carrying out recording/reproduction of the above-described program in the flexible disk FD. In the case of recording the above-described program for realizing the moving image coding method or the moving image decoding method in the flexible disk FD, the program is written from a computer system Cs through a flexible disk drive. Furthermore, in the case of constructing the moving image coding method or the moving image decoding method described above in the computer system using the program in the flexible disk, the program is read from the flexible disk with the flexible disk drive, and transferred to the computer system.

Although a flexible disk is used as the recording medium in the above description, the present invention can be similarly performed using an optical disk. Additionally, the recording medium is not limited to these, and the present invention can be similarly performed using any medium such as IC card or ROM cassette that is capable of recording a program.

Forth Embodiment

Hereinafter, application examples of the moving image coding method or the moving image decoding method shown in the above-described embodiments, and a system using the same will be described.

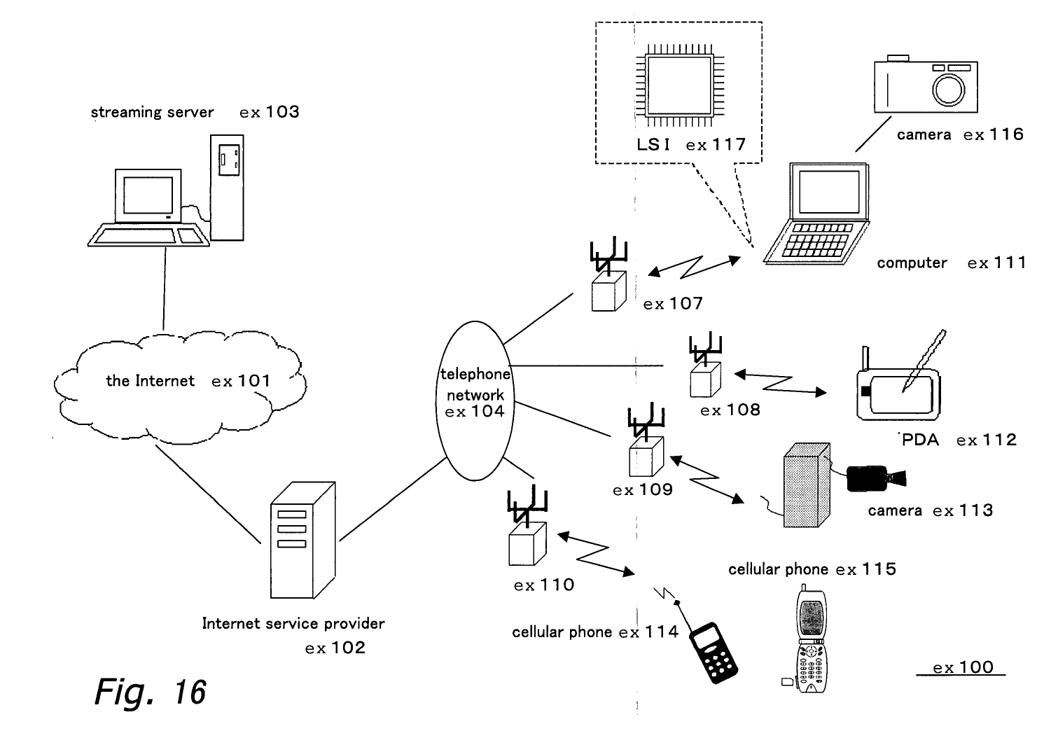

FIG. 16 is a block diagram showing an overall structure of a content providing system ex100 that realizes a content delivering service. An area where a communication service is provided is divided into cells of a desired size, and base stations ex107-ex110 that are fixed radio stations are provided in the cells.

This content providing system ex100 includes a computer ex111, a personal digital assistant (PDA) ex112, a camera ex113, a cellular phone ex114, a cellular phone with camera ex115 and other equipment that are connected to the Internet ex101 for example via an internet service provider ex102, a telephone network ex104 and base stations ex107-ex110.

However, the content providing system ex100 can adopt any combination for connection without being limited to the combination shown in FIG. 16. In addition, each of the devices can be connected directly to the telephone network ex104 without the base stations ex107-ex110 that are fixed radio stations.

The camera ex113 is a device such as a digital video camera that can obtain a moving image. In addition, the cellular phone may be any type of PDC (Personal Digital Communications) method, CDMA (Code Division Multiple Access) method, W-CDMA (Wideband-Code Division Multiple Access) method, or GSM (Global System for Mobile Communications) method, or a cellular phone of PH (Personal Handyphone System).

In addition, the streaming server ex103 is connected to the camera ex113 via the base station ex109 and the telephone network ex104, so that live delivery can be performed on the basis of coded data transmitted by a user of the camera ex113. The coding process of the obtained data may be performed by the camera ex113 or by a server for transmitting data. In addition, the moving image data obtained by the camera ex116 may be transmitted to the streaming server ex103 via the computer ex111. The camera ex116 is a device that can take a still image like a digital camera and a moving image. In this case, coding of the moving image data may be performed by the camera ex116 or by the computer ex111. In addition, the coding process may be performed by an LSI ex117 in the computer ex111 or the camera ex116. Note that it is possible to incorporate software for coding and decoding images into a storage medium (a CD-ROM, a flexible disk, a hard disk or the like) that is a recording medium readable by the computer ex111. Furthermore, the cellular phone with camera ex115 may transmit the moving image data. In this case, the moving image data is coded by the LSI in the cellular phone ex115.

In this content providing system ex100, content (for example, a moving image of a music concert) that the user is recording with the camera ex113 or the camera ex116 are coded as shown in the above-described embodiments and transmitted to the streaming server ex103, while the streaming server ex103 delivers a stream of the content data to a client who made a request. The client may be the computer ex111, the PDA ex112, the camera ex113, the cellular phone ex114 or the like that can decode the coded data. Thus, in the content providing system ex100, the client can receive and reproduce the coded data. The system can realize personal broadcasting when the client receives, decodes and reproduces the stream in real time.

To perform coding or decoding with the devices of this system, the moving image coding device or the moving image decoding device shown in the above-described embodiments may be used.

An example regarding a cellular phone will now be described.

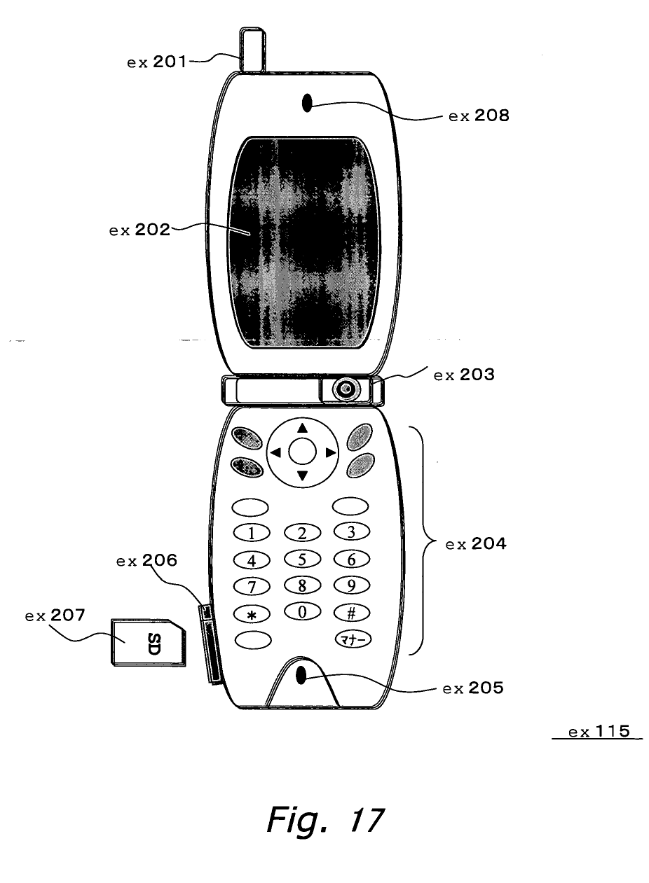

FIG. 17 shows the cellular phone ex115 that utilizes the moving image coding method or the moving image decoding method of the present invention. The cellular phone ex115 includes an antenna ex201 for transmitting and receiving radio waves with the base station ex110, a camera portion ex203 such as a CCD camera that can take a still image, a display portion ex202 such as a liquid crystal display for displaying images obtained by the camera portion ex203 or images received by the antenna ex201 after the image data are decoded, a main body portion including a group of operating keys ex204, a sound output portion ex208 such as a speaker for producing sounds, a sound input portion ex205 such as a microphone for receiving sounds, a recording medium ex207 for storing coded data or decoded data such as data of taken moving images or still images, data of received e-mails, moving images or still images, and a slot portion ex206 that enables the recording medium ex207 to be attached to the cellular phone ex115. The recording medium ex207 such as an SD card includes a plastic case housing a flash memory element that is one type of EEPROM (Electrically Erasable and Programmable Read Only Memory) nonvolatile memory that is electronically rewritable and erasable.

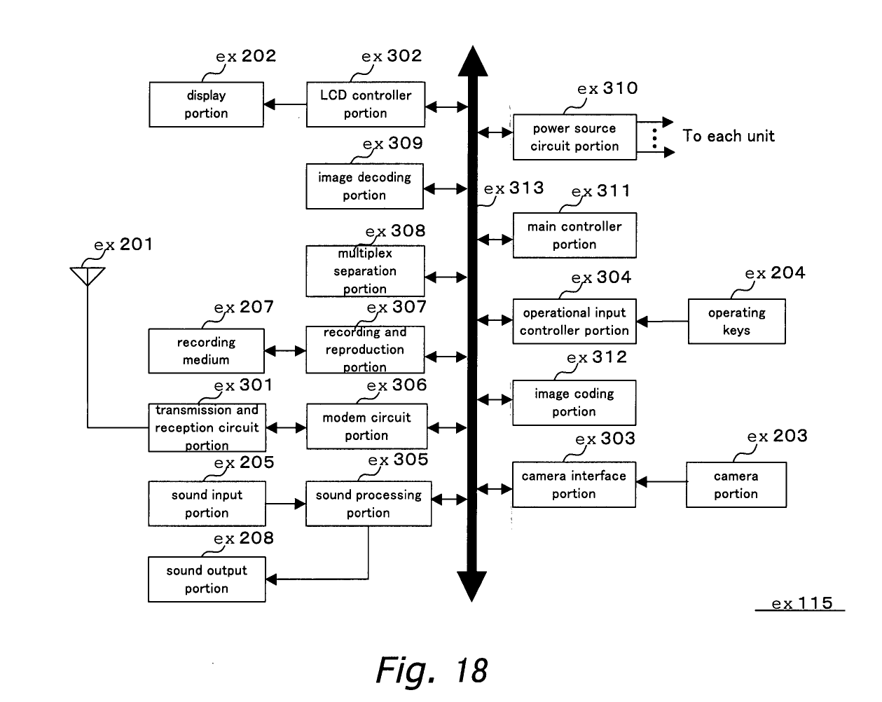

Furthermore, the cellular phone ex115 will be described with reference to FIG. 18. The cellular phone ex115 includes a main controller portion ex311 for controlling each portion of the main body portion having the display portion ex202 and the operating keys ex204, a power source circuit portion ex310, an operational input controller portion ex304, an image coding portion ex312, a camera interface portion ex303, an LCD (Liquid Crystal Display) controller portion ex302, an image decoding portion ex309, a multiplex separation portion ex308, a recording and reproduction portion ex307, a modem circuit portion ex306 and a sound processing portion ex305, which are connected to each other via a synchronizing bus ex313.

When the user turns on a clear and power key, the power source circuit portion ex310 supplies power from a battery pack to each portion so that the digital cellular phone with camera ex115 is activated.

The cellular phone ex115 converts a sound signal collected by the sound input portion ex205 during a sound communication mode into digital sound data by the sound processing portion ex305 under control of the main controller portion ex311 that includes a CPU, a ROM and a RAM. The digital sound data are processed by the modem circuit portion ex306 as a spectrum spreading process and are processed by the transmission and reception circuit portion ex301 as a digital to analog conversion process and a frequency conversion process. After that, the data are transmitted via the antenna ex201. In addition, the cellular phone ex115 amplifies a signal that is received by the antenna ex201 during the sound communication mode and performs the frequency conversion process and an analog to digital conversion process on the data, which is processed by the modem circuit portion ex306 as a spectrum inverse spreading process and is converted into a analog sound signal by the sound processing portion ex305. After that, the analog sound signal is delivered by the sound output portion ex208.

Furthermore, when transmitting electronic mail during a data communication mode, text data of the electronic mail are entered by using the operating keys ex204 of the main body portion and are given to the main controller portion ex311 via the operational input controller portion ex304. The main controller portion ex311 performs the spectrum spreading process on the text data by the modem circuit portion ex306 and performs the digital to analog conversion process and the frequency conversion process by the transmission and reception circuit portion ex301. After that, the data are transmitted to the base station ex110 via the antenna ex201.

When transmitting image data during the data communication mode, the image data obtained by the camera portion ex203 are supplied to the image coding portion ex312 via the camera interface portion ex303. In addition, if the image data are not transmitted, it is possible to display the image data obtained by the camera portion ex203 directly by the display portion ex202 via the camera interface portion ex303 and an LCD controller portion ex302.

The image coding portion ex312, which comprises the moving image coding device of the present invention, converts the image data supplied from the camera portion ex203 into the coded image data by compressing and coding the data by the coding method which is used by the image coding device shown in the above-described embodiments, and the coded image data are supplied to the multiplex separation portion ex308. In addition, the cellular phone ex115 collects sounds by the sound input portion ex205 while the camera portion ex203 is taking the image, and the digital sound data is supplied from the sound processing portion ex305 to the multiplex separation portion ex308.

The multiplex separation portion ex308 performs multiplexing of the coded image data supplied from the image coding portion ex312 and the sound data supplied from the sound processing portion ex305 by a predetermined method. Multiplexed data obtained as a result are processed by the modem circuit portion ex306 as a spectrum spreading process and are processed by the transmission and reception circuit portion ex301 as a digital to analog conversion process and a frequency conversion process. After that, the data are transmitted via the antenna ex201.

When receiving moving image file data that are linked to a web page during the data communication mode, a signal received from the base station ex110 via the antenna ex201 is processed by the modem circuit portion ex306 as a spectrum inverse spreading process. Multiplexed data obtained as a result are supplied to the multiplex separation portion ex308.

In addition, in order to decode multiplexed data received via the antenna ex201, the multiplex separation portion ex308 separates a coded bit stream of image data in the multiplexed data from a coded bit stream of sound data. Then, the multiplex separation portion ex308 supplies the coded image data to the image decoding portion ex309 via the synchronizing bus ex313 and supplies the sound data to the sound processing portion ex305.

Next, the image decoding portion ex309, which comprises the moving image coding device of the present invention, generates reproduction moving image data by decoding the coded bit stream of the image data by the decoding method corresponding to the coding method shown in the above-described embodiments and supplies the data to the display portion ex202 via the LCD controller portion ex302. Thus, the moving image data included in a moving image file that is linked to a home page can be displayed. In this case, the sound processing portion ex305 converts the sound data into an analog sound signal, which is supplied to the sound output portion ex208. Thus, sound data included in the moving image file that is linked to a home page can be reproduced.

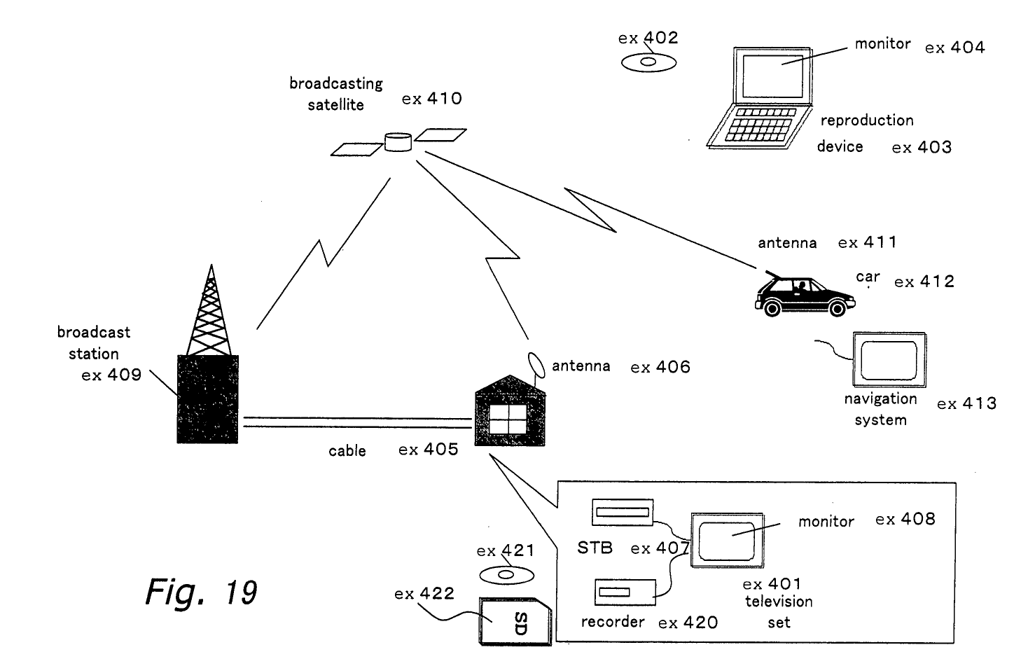

Note that the present invention is not limited to the example of the system described above. Digital broadcasting by satellite or terrestrial signals has been a recent topic of discussion. As shown in FIG. 19, the image coding device or the image decoding device of the present invention can be incorporated into the digital broadcasting system, too.

More specifically, in a broadcast station ex409, a coded bit stream of image information is sent to a communication or a broadcasting satellite ex410 via a radio wave. The broadcasting satellite ex410 that received the coded bit stream of image information sends radio waves for broadcasting. These radio waves are received by an antenna ex406 of a house equipped with a satellite broadcasting reception facility, and a device such as a television set (a receiver) ex401 or a set top box (STB) ex407 decodes the coded bit stream and reproduces the same. In addition, a reproduction device ex403 for reading and decoding a coded bit stream that is recorded on a storage medium ex402 such as a CD or a DVD that is a recording medium may be equipped with the image decoding device. In this case, the reproduced image signal and text track are displayed on a monitor ex404. In addition, it is possible to mount the image decoding device of the present invention in a set top box ex407 that is connected to a cable ex405 for a cable television or the antenna ex406 for a satellite or surface wave broadcasting, so that the image can be reproduced on a monitor ex408 of the television set. In this case, it is possible to incorporate the image decoding device of the present invention not into the set top box but into the television set. In addition, it is possible that a car ex412 equipped with an antenna ex411 receives a signal from the broadcasting satellite ex410 or the base station ex107 and reproduces the moving image on a display of a navigation system ex413 in the car ex412.

Furthermore, it is possible to encode the image signal with the image coding device and record the encoded image signal in a recording medium. As a specific example, there is a recorder ex420 such as a DVD recorder for recording image signals on a DVD disk ex421 or a disk recorder for recording image signals on a hard disk. Furthermore, it is possible to record on an SD card ex422. In addition, in case that the recorder ex420 includes the image decoding device of the present invention, it is possible to reproduce image signals recorded on a DVD disk ex421 or a SD card ex422 via the image signal processing device, so as to display on the monitor ex408.

Note that in the structure of the navigation system ex413 shown in FIG. 18, the camera portion ex203, the camera interface portion ex303 and the image coding portion ex312 can be omitted. This can be also applied to the computer ex111 and the television set (the receiver) ex401.

In addition, the terminal device such as the cellular phone ex114 may include three types of assemblies. A first type is a transmission and reception terminal having both the coder and the decoder, a second type is a transmission terminal having only a coder and a third type is a reception terminal having only a decoder.

Thus, the moving image coding method and the moving image decoding method shown in the above-described embodiments can be used for any device and system described above, so that effects described above can be obtained.

Note that each functional block in block diagrams of the image coding device and the image decoding device are typically realized as an LSI that is an integrated circuit. These may be one chip individually, and also may be one tip as a part of them or as a whole.

For example, each functional block in FIG. 1 or FIG. 2 may be one chip. In this situation, the image memory 122 may be externally connected with the chip.

In addition, each functional block in FIG. 13 may be one chip. In this situation, the image memory 318 may be externally connected with the chip.

The LSI may be referred to as an IC, a system LSI, a super LSI or an ultra LSI in accordance with the degree of integration.

In addition, a method for integrating circuits is not limited to an LSI but it may be realized by an application specific integrated circuit or a versatile processing unit. It is possible to use an FPGA (Field Programmable Gate Array) that is programmable after the LSI is produced or a silicon figurable processor that can restructure connection or setting of circuit cells in the LSI.

Furthermore, if another technique for integrating circuits rather than he LSI appears with the progress of semiconductor technology, then that technique may be utilized for integrating the functional blocks. Biotechnology has the potential for such technology.

In addition, all of or a part of the process of each functional block of the above embodiments may be realized by utilizing programs. In this case, CPUs, for example, perform the process. Furthermore, the programs for the processes are stored in the hard disc devices or the ROMs, and are read out to the ROMs or the RAMs so as to be performed.

The moving image coding method and the moving image decoding method according to the present invention have an effect that coding and decoding can be performed with a low bit rate and a high image quality, and they are useful for a method of coding a moving image and a method of decoding a moving image in accumulation, transmission, communication and the like.

This application claims priority to Japanese Patent Application No. 2004-132848. The entire disclosure of Japanese Patent Application No. 2004-132848 is hereby incorporated herein by reference.

While only selected embodiments have been chosen to illustrate the present invention, it will be apparent to those skilled in the art from this disclosure that various changes and modifications can be made herein without departing from the scope of the invention as defined in the appended claims. Furthermore, the foregoing description of the embodiments according to the present invention are provided for illustration only, and not for the purpose of limiting the invention as defined by the appended claims and their equivalents.

1. A method for coding a moving image by generating prediction images based upon images that are motion compensated by means of motion information between frames of the moving image, and by coding an input image, the method comprising:
an image quality deterioration prediction process for determining a degree of image quality deterioration of the coded image in accordance with motion information between frames; and
a code quantity distribution process for changing a method of distributing the code quantity generated by coding in accordance with the degree of image quality deterioration.

2. The method according to claim 1, wherein the image quality deterioration prediction process includes deciding that the degree of image quality deterioration is high if the coded image has a different motion from surroundings, and deciding that the degree of image quality deterioration is low if the coded image has the same motion as surroundings.

3. The method according to claim 1, wherein the code quantity distribution process is for selecting a coding mode from a plurality of coding mode candidates and comprising:
a generated code quantity calculation process for calculating generated code quantity of each of the coding mode candidates;
an input image difference quantity calculation process for calculating input image difference quantity between the coded image and the input image for each of the coding mode candidates; and
a coding mode selection process for selecting a coding mode in accordance with the degree of image quality deterioration, the generated code quantity and the input image difference quantity.

4. The method according to claim 1, wherein the code quantity distribution process comprises:
a quantization control process for setting accuracy of quantization to a high value when the degree of image quality deterioration is high, and setting the accuracy of quantization to a low value when the degree of image quality deterioration is low; and
a quantization process for performing quantization in accordance with the set accuracy of quantization.

5. The method according to claim 3, wherein
the code quantity distribution process further comprising:
a quantization control process for setting accuracy of quantization to a high value when the degree of image quality deterioration is high and setting the accuracy of quantization to a low value when the degree of image quality deterioration is low; and
a quantization process for performing quantization in accordance with the set accuracy of quantization; and
the coding mode selection process includes selecting the coding mode in accordance with the degree of image quality deterioration, the generated code quantity and the input image difference quantity when the quantization control process changes the accuracy of quantization.

6. The method according to claim 2, wherein the code quantity distribution process includes increasing a code quantity distribution if the degree of image quality deterioration is determined to be high and decreasing the code quantity distribution if the degree of image quality deterioration is determined to be low.

7. A method for coding a moving image by generating a prediction image and coding an input image, the method comprising:
a subtraction process for subtracting the prediction image from the input image so as to deliver a differential image;
an orthogonal transformation process for performing an orthogonal transformation on the differential image so as to deliver a transformed coefficient;
a coefficient modulation process for performing a coefficient modulation on the transformed coefficient so as to deliver a modulated coefficient;
a modulation mode selection process for switching among a plurality of modulation mode candidates that indicate degrees of the coefficient modulation;
a quantization process for quantizing the modulated coefficient so as to deliver quantized information; and
a variable length coding process for performing variable length coding on the quantized information so as to deliver a coded stream, wherein
the coefficient modulation process includes performing the coefficient modulation for decreasing a value of the coefficient that indicates a high frequency component of the transformed coefficient by different modulation modes corresponding to degrees of the coefficient modulation, and
the modulation mode is determined in accordance with generated code quantity of each of the modulation mode candidates and input image difference quantity of each of the modulation mode candidates.

8. The method according to claim 7, wherein the variable length coding process performs the variable length coding on the selection information of the modulation mode.

9. The method according to claim 7, wherein the coefficient modulation process can selects different modulation modes for process units of coding.

10. A method for decoding a moving image coded stream, the method comprising:
a variable length decoding process for performing variable length decoding on the moving image coded stream so as to deliver quantized information and motion information;
an inverse quantization process for performing inverse quantization on the quantized information so as to deliver a transformed coefficient;
an inverse orthogonal transformation process for performing inverse orthogonal transformation on the transformed coefficient;
an image quality deterioration prediction process for determining a degree of image quality deterioration of a coded image in accordance with the motion information; and
an image quality improving process for improving image quality if the degree of image quality deterioration is high.

11. The method according to claim 10, wherein the image quality improving process includes increasing the high frequency components of the differential information obtained in the inverse orthogonal transformation process.

12. The method according to claim 10, wherein the image quality improving process includes using a smoothing filter on a decoded image in an area having a high value of the degree of image quality deterioration.

13. A device for coding a moving image by generating a prediction image in accordance with an image that is processed of motion compensation with motion information between frames of the moving image, and by coding an input image, the device comprising:
an image quality deterioration predictor that determines degree of image quality deterioration of a coded image in accordance with motion information between frames; and
a code quantity distributor that changes a method for distributing code quantity that is generated by coding in accordance with the degree of image quality deterioration, wherein
the image quality deterioration predictor determines that the degree of image quality deterioration is high if the coded image has a different motion from surroundings, and determines that the degree of image quality deterioration is low if the coded image has the same motion as surroundings.

14. The device according to claim 13, wherein the code quantity distributor increases code quantity distribution if the degree of image quality deterioration is determined to be high, and decreases the code quantity distribution if the degree of image quality deterioration is determined to be low.

15. A device for coding a moving image by generating a prediction image and coding an input image, the device comprising:
a subtractor for subtracting the prediction image from the input image;
an orthogonal transformer for performing orthogonal transformation on a differential image that is obtained by the subtractor;
a coefficient modulator for performing coefficient modulation on the transformed coefficient that is obtained by the orthogonal transformer;
a quantizer for quantizing a modulated coefficient that is obtained by the coefficient modulator; and
a variable length coder for performing variable length coding on quantized information obtained by the quantizer, wherein
the coefficient modulator performs the coefficient modulation for decreasing a coefficient value indicating high frequency components of the transformed coefficient in different modulation modes corresponding to degrees of the coefficient modulation for each process unit of coding, and
the modulation mode is selected from a plurality of modulation mode candidates indicating degrees of the coefficient modulation in accordance with generated code quantity of each of the modulation mode candidates and input image difference quantity of each of the modulation mode candidates.

16. A device for decoding a moving image coded stream, the device comprising:
a variable length decoder for performing variable length decoding on the moving image coded stream;
an inverse quantizer for performing inverse quantization on the quantized information that is obtained by the variable length decoder;
an inverse orthogonal transformer for performing inverse orthogonal transformation on the transformed coefficient obtained by the inverse quantizer;
an image quality deterioration predictor for determining a degree of image quality deterioration of a coded image in accordance with the motion information obtained by the variable length decoder; and
an image quality improver for improving image quality if the degree of image quality deterioration is high.

17. A program product for coding a moving image using a computer, including a method for coding a moving image which generates a prediction image in accordance with an image that is processed of motion compensation using motion information between frames of the moving image, and which codes an input image, the program product making the computer execute the method comprising:
an image quality deterioration prediction process for determining a degree of image quality deterioration of the coded image in accordance with motion information between frames; and
a code quantity distribution process for changing a method of distributing the code quantity generated by coding in accordance with the degree of image quality deterioration.

18. The program product according to claim 17, wherein
the image quality deterioration prediction process includes deciding that the degree of image quality deterioration is high if the coded image has a different motion from surroundings, and deciding that the degree of image quality deterioration is low if the coded image has the same motion as surroundings, and
the code quantity distribution process includes increasing a code quantity distribution if the degree of image quality deterioration is determined to be high and decreasing the code quantity distribution if the degree of image quality deterioration is determined to be low.

19. A program product for coding a moving image using a computer, including a method for coding a moving image which generates a prediction image and codes an input image, the program product making the computer execute the method comprising:
a subtraction process for subtracting the prediction image from the input image;
an orthogonal transformation process for performing an orthogonal transformation on the differential image that is obtained in the subtraction process;
a coefficient modulation process for performing a coefficient modulation on the transformed coefficient that is obtained in the orthogonal transformation process;
a quantization process for quantizing the modulated coefficient that is obtained in the coefficient modulation process; and
a variable length coding process for performing variable length coding on the quantized information that is obtained in the quantization process, wherein
the coefficient modulation process includes performing the coefficient modulation for decreasing a value of the coefficient that indicates a high frequency component of the transformed coefficient by different modulation modes corresponding to degrees of the coefficient modulation, and
the modulation mode is selected from a plurality of modulation mode candidates indicating degrees of the coefficient modulation in accordance with generated code quantity of each of the modulation mode candidates and input image difference quantity of each of the modulation mode candidates.

20. A program product for decoding a moving image coded stream using a computer, including a method for decoding a moving image which decodes a moving image coded stream, the program product makes the computer execute the method comprising:
a variable length decoding process for performing variable length decoding on the moving image coded stream;
an inverse quantization process for performing inverse quantization on the quantized information that is obtained in the variable length decoding process;
an inverse orthogonal transformation process for performing inverse orthogonal transformation on the transformed coefficient that is obtained in the inverse quantization process;
an image quality deterioration prediction process for determining a degree of image quality deterioration of a coded image in accordance with the motion information that is obtained in the variable length decoding process; and
an image quality improving process for improving image quality if the degree of image quality deterioration is high.

21. An integrated circuit device for coding an input image by generating a prediction image in accordance with an image whose motion is compensated by motion information between frames in a moving image, the device comprising:
an image quality deterioration prediction portion that determines degree of image quality deterioration of a coded image in accordance with motion information between frames; and
a code quantity distribution portion that changes a method for distributing code quantity that is generated by coding in accordance with the degree of image quality deterioration, wherein
the image quality deterioration prediction portion determines that the degree of image quality deterioration is high if the coded image has a different motion from surroundings, and determines that the degree of image quality deterioration is low if the coded image has the same motion as surroundings.

22. The integrated circuit device according to claim 21, wherein the code quantity distribution portion increases code quantity distribution if the degree of image quality deterioration is determined to be high, and decreases the code quantity distribution if the degree of image quality deterioration is determined to be low.

23. An integrated circuit device for generating a prediction image and coding an input image, comprising:
a subtraction portion for subtracting the prediction image from the input image;
an orthogonal transformation portion for performing an orthogonal transformation on the differential image that is obtained by the subtraction portion;
a coefficient modulation portion for performing a coefficient modulation on the transformed coefficient that is obtained by the orthogonal transformation portion;
a quantization process for quantizing the modulated coefficient that is obtained by the coefficient modulation portion; and
a variable length coding process for performing variable length coding on the quantized information that is obtained by the quantizing portion, wherein
the coefficient modulation portion performs the coefficient modulation for decreasing a coefficient value indicating high frequency components of the transformed coefficient in different modulation modes corresponding to degrees of the coefficient modulation for each process unit of coding, and
the modulation mode is selected from a plurality of modulation mode candidates indicating degrees of the coefficient modulation in accordance with generated code quantity of each of the modulation mode candidates and input image difference quantity of each of the modulation mode candidates.

24. An integrated circuit device for decoding a moving image coded stream, the device comprising:
a variable length decoding portion for performing variable length decoding on the moving image coded stream;
an inverse quantization portion for performing inverse quantization on the quantized information that is obtained by the variable length decoding portion;
an inverse orthogonal transformation portion for performing inverse orthogonal transformation on the transformed coefficient that is obtained by the inverse quantization portion;
an image quality deterioration prediction portion for determining a degree of image quality deterioration of a coded image in accordance with the motion information that is obtained by the variable length decoding portion; and
an integrated circuit device for improving image quality if the degree of image quality deterioration is high.

25. A data structure of a coded stream obtained by generating a prediction image in accordance with an image whose motion is compensated by motion information between frames in a moving image so as to code an input image, wherein
the data includes a plurality of process unit information that is generated for each of divided areas of the input image and includes the motion information and differential information between the input image and the prediction image, and
code quantity of the differential information of the process unit information corresponds to a difference between the motion information included in the process unit information and the motion information included in surrounding process unit information.
